(19) United States
(12) Patent Application Publication
(10) Pub. No.: US 2025/0226847 A1
(43) Pub. Date: Jul. 10, 2025

(54) COMMUNICATING BETWEEN DEVICES

(71) Applicant: Apple Inc., Cupertino, CA (US)

(72) Inventors: Onur E. TACKIN, Saratoga, CA (US); Cahya A. MASPUTRA, San Jose, CA (US); Dhruv SAMANT, Mountain View, CA (US); Junjue WANG, Newark, CA (US); Mahmut DEMIR, Pleasanton, CA (US); Najeeb M. ABDULRAHIMAN, Fremont, CA (US); Ranjit DESAI, Cupertino, CA (US); Samuel D. POST, Great Falls, MT (US); Shilpa A. GEORGE, San Jose, CA (US); Stephen C. SCHWEIZER, Mountain View, CA (US)

(21) Appl. No.: 18/921,382

(22) Filed: Oct. 21, 2024

Related U.S. Application Data
(60) Provisional application No. 63/618,802, filed on Jan. 8, 2024.

(51) Int. Cl. H04B 1/401; H04W 4/02; H04W 12/50; H04W 28/02

(52) U.S. Cl. CPC H04B 1/401; H04W 4/023; H04W 12/50; H04W 28/0221

(57) ABSTRACT

The present disclosure generally relates to controlling computer systems.

### CROSS-REFERENCE TO RELATED APPLICATIONS

The present application claims priority to U.S. Provisional Patent Application Ser. No. 63/618,802, entitled “COMMUNICATING BETWEEN DEVICES,” filed Jan. 8, 2024 which is hereby incorporated by reference in its entirety for all purposes.

### BACKGROUND

Today, electronic devices are sometimes coupled to other devices for ensuring that the electronic devices maintain a particular position. For example, a phone can be coupled to a mount on a nightstand so that the phone stays facing a particular direction in a room. However, such configurations are rigid in that a user must manually place the phone in a direction that the user wants the phone. Accordingly, there is a need to improve techniques for controlling devices.

### SUMMARY

Current techniques for controlling devices are generally ineffective and/or inefficient. For example, some techniques require users to physically place devices in particular positions. This disclosure provides more effective and/or efficient techniques for controlling devices using an example of a phone communicating with another device while the phone is attached to a mount. It should be recognized that other types of electronic devices can be used with techniques described herein. For example, a smart display, a smart speaker, and/or other types of devices can be controlled using techniques described herein. In addition, techniques optionally complement or replace other techniques for controlling electronic devices.

Some techniques are described herein for a first device to receive position information from a second device and, in response, control a state of an input and/or output (I/O) of the first device and/or an I/O component of a third device. For example, a head-mounted display (HMD) device (e.g., the second device) can send position information of the HMD device (e.g., in what direction the HMD device is facing) to a phone (e.g., the first device) so that the phone can digitally zoom content captured by a camera of the phone and/or cause a mount (e.g., the third device) that is coupled to the phone to physically move (and, as a result, physically move the phone) in a manner corresponding to how the HMD device is moving. Other techniques are described herein for a first device to convert position information received from a second device to instructions for a third device. Such techniques can be used while the first device is sending media captured by a camera of the first device to the second device, such as part of a video call between the two devices. For example, while a first phone (e.g., the first device) is on a video call with a second phone (e.g., the second device), the first phone can receive position information from the second phone to cause the first phone to convert such position information to instructions for controlling a physical position of a mount coupled to the first phone.

In some embodiments, a method that is performed at a first device is described. In some embodiments, the method comprises: receiving, from a second device different from the first device, first respective position information of the second device; and in response to receiving the first respective position information of the second device: in accordance with a determination that the first respective position information includes first position information, changing, based on the first respective position information, a state of an input and/or output (I/O) component of the first device; and in accordance with a determination that the first respective position information includes second position information different from the first position information, changing, based on the first respective position information, a state of an I/O component of a third device different from the first device and the second device.

In some embodiments, a non-transitory computer-readable storage medium storing one or more programs configured to be executed by one or more processors of a first device is described. In some embodiments, the one or more programs includes instructions for: receiving, from a second device different from the first device, first respective position information of the second device; and in response to receiving the first respective position information of the second device: in accordance with a determination that the first respective position information includes first position information, changing, based on the first respective position information, a state of an input and/or output (I/O) component of the first device; and in accordance with a determination that the first respective position information includes second position information different from the first position information, changing, based on the first respective position information, a state of an I/O component of a third device different from the first device and the second device.

In some embodiments, a transitory computer-readable storage medium storing one or more programs configured to be executed by one or more processors of a first device is described. In some embodiments, the one or more programs includes instructions for: receiving, from a second device different from the first device, first respective position information of the second device; and in response to receiving the first respective position information of the second device: in accordance with a determination that the first respective position information includes first position information, changing, based on the first respective position information, a state of an input and/or output (I/O) component of the first device; and in accordance with a determination that the first respective position information includes second position information different from the first position information, changing, based on the first respective position information, a state of an I/O component of a third device different from the first device and the second device.

In some embodiments, a first device is described. In some embodiments, the first device comprises one or more processors and memory storing one or more programs configured to be executed by the one or more processors. In some embodiments, the one or more programs includes instructions for: receiving, from a second device different from the first device, first respective position information of the second device; and in response to receiving the first respective position information of the second device: in accordance with a determination that the first respective position information includes first position information, changing, based on the first respective position information, a state of an input and/or output (I/O) component of the first device; and in accordance with a determination that the first respective position information includes second position information different from the first position information, changing, based on the first respective position information, a state of an I/O component of a third device different from the first device and the second device.

In some embodiments, a first device is described. In some embodiments, the first device comprises means for performing each of the following steps: receiving, from a second device different from the first device, first respective position information of the second device; and in response to receiving the first respective position information of the second device: in accordance with a determination that the first respective position information includes first position information, changing, based on the first respective position information, a state of an input and/or output (I/O) component of the first device; and in accordance with a determination that the first respective position information includes second position information different from the first position information, changing, based on the first respective position information, a state of an I/O component of a third device different from the first device and the second device.

In some embodiments, a computer program product is described. In some embodiments, the computer program product comprises one or more programs configured to be executed by one or more processors of a first device. In some embodiments, the one or more programs include instructions for: receiving, from a second device different from the first device, first respective position information of the second device; and in response to receiving the first respective position information of the second device: in accordance with a determination that the first respective position information includes first position information, changing, based on the first respective position information, a state of an input and/or output (I/O) component of the first device; and in accordance with a determination that the first respective position information includes second position information different from the first position information, changing, based on the first respective position information, a state of an I/O component of a third device different from the first device and the second device.

In some embodiments, a method that is performed at a first device is described. In some embodiments, the method comprises: receiving, from a second device different from the first device, first position information of the second device; after receiving the first position information of the second device, converting the first position information of the second device to a first set of one or more instructions to control a first input and/or output (I/O) component of a third device, wherein the third device is different from the first device and the second device; and after converting the first position information of the second device to the first set of one or more instructions, sending, to the third device, the first set of one or more instructions while sending media data to the second device.

In some embodiments, a non-transitory computer-readable storage medium storing one or more programs configured to be executed by one or more processors of a first device is described. In some embodiments, the one or more programs includes instructions for: receiving, from a second device different from the first device, first position information of the second device; after receiving the first position information of the second device, converting the first position information of the second device to a first set of one or more instructions to control a first input and/or output (I/O) component of a third device, wherein the third device is different from the first device and the second device; and after converting the first position information of the second device to the first set of one or more instructions, sending, to the third device, the first set of one or more instructions while sending media data to the second device.

In some embodiments, a transitory computer-readable storage medium storing one or more programs configured to be executed by one or more processors of a first device is described. In some embodiments, the one or more programs includes instructions for: receiving, from a second device different from the first device, first position information of the second device; after receiving the first position information of the second device, converting the first position information of the second device to a first set of one or more instructions to control a first input and/or output (I/O) component of a third device, wherein the third device is different from the first device and the second device; and after converting the first position information of the second device to the first set of one or more instructions, sending, to the third device, the first set of one or more instructions while sending media data to the second device.

In some embodiments, a first device is described. In some embodiments, the first device comprises one or more processors and memory storing one or more programs configured to be executed by the one or more processors. In some embodiments, the one or more programs includes instructions for: receiving, from a second device different from the first device, first position information of the second device; after receiving the first position information of the second device, converting the first position information of the second device to a first set of one or more instructions to control a first input and/or output (I/O) component of a third device, wherein the third device is different from the first device and the second device; and after converting the first position information of the second device to the first set of one or more instructions, sending, to the third device, the first set of one or more instructions while sending media data to the second device.

In some embodiments, a first device is described. In some embodiments, the first device comprises means for performing each of the following steps: receiving, from a second device different from the first device, first position information of the second device; after receiving the first position information of the second device, converting the first position information of the second device to a first set of one or more instructions to control a first input and/or output (I/O) component of a third device, wherein the third device is different from the first device and the second device; and after converting the first position information of the second device to the first set of one or more instructions, sending, to the third device, the first set of one or more instructions while sending media data to the second device.

In some embodiments, a computer program product is described. In some embodiments, the computer program product comprises one or more programs configured to be executed by one or more processors of a first device. In some embodiments, the one or more programs include instructions for: receiving, from a second device different from the first device, first position information of the second device; after receiving the first position information of the second device, converting the first position information of the second device to a first set of one or more instructions to control a first input and/or output (I/O) component of a third device, wherein the third device is different from the first device and the second device; and after converting the first position information of the second device to the first set of one or more instructions, sending, to the third device, the first set of one or more instructions while sending media data to the second device.

Executable instructions for performing these functions are, optionally, included in a non-transitory computer-readable storage medium or other computer program product configured for execution by one or more processors. Executable instructions for performing these functions are, optionally, included in a transitory computer-readable storage medium or other computer program product configured for execution by one or more processors.

### DESCRIPTION OF THE FIGURES

For a better understanding of the various described embodiments, reference should be made to the Detailed Description below, in conjunction with the following drawings in which like reference numerals refer to corresponding parts throughout the figures.

FIG. 1 is a block diagram illustrating a compute system in accordance with some embodiments.

FIG. 2 is a block diagram illustrating a device with interconnected subsystems in accordance with some embodiments.

FIG. 3A is a block diagram illustrating a phone and a mount in accordance with some embodiments.

FIG. 3B is a block diagram illustrating a mount coupled to a phone in accordance with some embodiments.

FIG. 4 is a flow diagram illustrating operations performed by a phone and a mount

before, during, and after establishing a secure communication in accordance with some embodiments.

FIG. 5 is a flow diagram illustrating a method for establishing a secure communication in accordance with some embodiments.

FIGS. 6A-6E illustrate exemplary user interfaces for communicating between devices in accordance with some embodiments.

FIGS. 7A-7B illustrate an exemplary communication diagram for communicating between devices in accordance with some embodiments.

FIG. 8 is a flow diagram illustrating a method for communicating between devices in accordance with some embodiments.

FIG. 9 is a flow diagram illustrating a method for communicating between devices in accordance with some embodiments.

### DETAILED DESCRIPTION

The following description sets forth exemplary methods, parameters, and the like. It should be recognized, however, that such description is not intended as a limitation on the scope of the present disclosure but is instead provided as a description of exemplary embodiments.

Processes described herein can include one or more steps that are contingent upon one or more conditions being satisfied. It should be understood that a method can occur over multiple iterations of the same process with different steps of the method being satisfied in different iterations. For example, if a method requires performing a first step upon a determination that a set of one or more criteria is met and a second step upon a determination that the set of one or more criteria is not met, a person of ordinary skill in the art would appreciate that the steps of the method are repeated until both conditions, in no particular order, are satisfied. Thus, a method described with steps that are contingent upon a condition being satisfied can be rewritten as a method that is repeated until each of the conditions described in the method are satisfied. This, however, is not required of system or computer readable medium claims where the system or computer readable medium claims include instructions for performing one or more steps that are contingent upon one or more conditions being satisfied. Because the instructions for the system or computer readable medium claims are stored in one or more processors and/or at one or more memory locations, the system or computer readable medium claims include logic that can determine whether the one or more conditions have been satisfied without explicitly repeating steps of a method until all of the conditions upon which steps in the method are contingent have been satisfied. A person having ordinary skill in the art would also understand that, similar to a method with contingent steps, a system or computer readable storage medium can repeat the steps of a method as many times as needed to ensure that all of the contingent steps have been performed.

Although the following description uses terms “first,” “second,” etc. to describe various elements, these elements should not be limited by the terms. In some embodiments, these terms are used to distinguish one element from another. For example, a first subsystem could be termed a second subsystem, and, similarly, a second subsystem device or a subsystem device could be termed a first subsystem device, without departing from the scope of the various described embodiments. In some embodiments, the first subsystem and the second subsystem are two separate references to the same subsystem. In some embodiments, the first subsystem and the second subsystem are both subsystems, but they are not the same subsystem or the same type of subsystem.

The terminology used in the description of the various described embodiments herein is for the purpose of describing particular embodiments only and is not intended to be limiting. As used in the description of the various described embodiments and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

The term “if” is, optionally, construed to mean “when,” “upon,” “in response to determining,” “in response to detecting,” or “in accordance with a determination that” depending on the context. Similarly, the phrase “if it is determined” or “if [a stated condition or event] is detected” is, optionally, construed to mean “upon determining,” “in response to determining,” “upon detecting [the stated condition or event],” “in response to detecting [the stated condition or event],” or “in accordance with a determination that [the stated condition or event]” depending on the context.

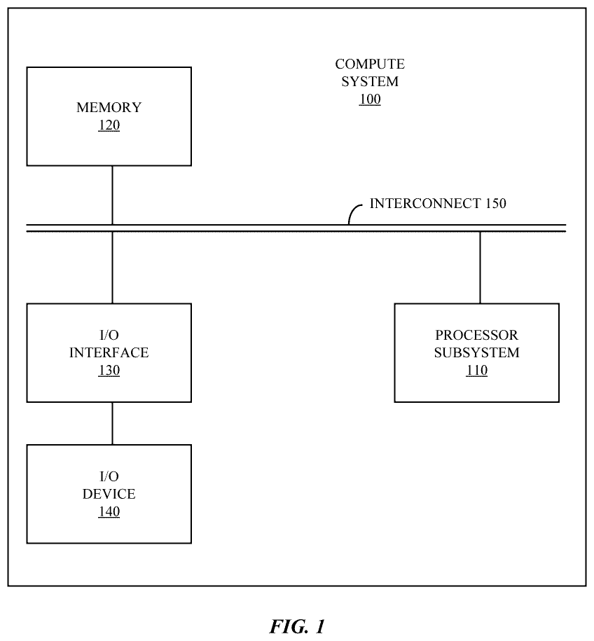

Turning to FIG. 1, a block diagram of compute system 100 is illustrated. Compute system 100 is a non-limiting example of a compute system that can be used to perform functionality described herein. It should be recognized that other computer architectures of a compute system can be used to perform functionality described herein.

In the illustrated example, compute system 100 includes processor subsystem 110 communicating with (e.g., wired or wirelessly) memory 120 (e.g., a system memory) and I/O interface 130 via interconnect 150 (e.g., a system bus, one or more memory locations, or other communication channel for connecting multiple components of compute system 100). In addition, I/O interface 130 is communicating with (e.g., wired or wirelessly) to I/O device 140. In some embodiments, I/O interface 130 is included with I/O device 140 such that the two are a single component. It should be recognized that there can be one or more I/O interfaces, with each I/O interface communicating with one or more I/O devices. In some embodiments, multiple instances of processor subsystem 110 can be communicating via interconnect 150.

Compute system 100 can be any of various types of devices, including, but not limited to, a system on a chip, a server system, a personal computer system (e.g., a smartphone, a smartwatch, a wearable device, a tablet, a laptop computer, and/or a desktop computer), a sensor, or the like. In some embodiments, compute system 100 is included or communicating with a physical component for the purpose of modifying the physical component in response to an instruction. In some embodiments, compute system 100 receives an instruction to modify a physical component and, in response to the instruction, causes the physical component to be modified. In some embodiments, the physical component is modified via an actuator, an electric signal, and/or algorithm. Examples of such physical components include an acceleration control, a break, a gear box, a hinge, a motor, a pump, a refrigeration system, a spring, a suspension system, a steering control, a pump, a vacuum system, and/or a valve. In some embodiments, a sensor includes one or more hardware components that detect information about a physical environment in proximity to (e.g., surrounding) the sensor. In some embodiments, a hardware component of a sensor includes a sensing component (e.g., an image sensor or temperature sensor), a transmitting component (e.g., a laser or radio transmitter), a receiving component (e.g., a laser or radio receiver), or any combination thereof. Examples of sensors include an angle sensor, a chemical sensor, a brake pressure sensor, a contact sensor, a non-contact sensor, an electrical sensor, a flow sensor, a force sensor, a gas sensor, a humidity sensor, an image sensor (e.g., a camera sensor, a radar sensor, and/or a LiDAR sensor), an inertial measurement unit, a leak sensor, a level sensor, a light detection and ranging system, a metal sensor, a motion sensor, a particle sensor, a photoelectric sensor, a position sensor (e.g., a global positioning system), a precipitation sensor, a pressure sensor, a proximity sensor, a radio detection and ranging system, a radiation sensor, a speed sensor (e.g., measures the speed of an object), a temperature sensor, a time-of-flight sensor, a torque sensor, and an ultrasonic sensor. In some embodiments, a sensor includes a combination of multiple sensors. In some embodiments, sensor data is captured by fusing data from one sensor with data from one or more other sensors. Although a single compute system is shown in FIG. 1, compute system 100 can also be implemented as two or more compute systems operating together.

In some embodiments, processor subsystem 110 includes one or more processors or processing units configured to execute program instructions to perform functionality described herein. For example, processor subsystem 110 can execute an operating system, a middleware system, one or more applications, or any combination thereof.

In some embodiments, the operating system manages resources of compute system 100. Examples of types of operating systems covered herein include batch operating systems (e.g., Multiple Virtual Storage (MVS)), time-sharing operating systems (e.g., Unix), distributed operating systems (e.g., Advanced Interactive executive (AIX), network operating systems (e.g., Microsoft Windows Server), and real-time operating systems (e.g., QNX). In some embodiments, the operating system includes various procedures, sets of instructions, software components, and/or drivers for controlling and managing general system tasks (e.g., memory management, storage device control, power management, or the like) and for facilitating communication between various hardware and software components. In some embodiments, the operating system uses a priority-based scheduler that assigns a priority to different tasks that processor subsystem 110 can execute. In such embodiments, the priority assigned to a task is used to identify a next task to execute. In some embodiments, the priority-based scheduler identifies a next task to execute when a previous task finishes executing. In some embodiments, the highest priority task runs to completion unless another higher priority task is made ready.

In some embodiments, the middleware system provides one or more services and/or capabilities to applications (e.g., the one or more applications running on processor subsystem 110) outside of what the operating system offers (e.g., data management, application services, messaging, authentication, API management, or the like). In some embodiments, the middleware system is designed for a heterogeneous computer cluster to provide hardware abstraction, low-level device control, implementation of commonly used functionality, message-passing between processes, package management, or any combination thereof. Examples of middleware systems include Lightweight Communications and Marshalling (LCM), PX4, Robot Operating System (ROS), and ZeroMQ. In some embodiments, the middleware system represents processes and/or operations using a graph architecture, where processing takes place in nodes that can receive, post, and multiplex sensor data messages, control messages, state messages, planning messages, actuator messages, and other messages. In such embodiments, the graph architecture can define an application (e.g., an application executing on processor subsystem 110 as described above) such that different operations of the application are included with different nodes in the graph architecture.

In some embodiments, a message sent from a first node in a graph architecture to a second node in the graph architecture is performed using a publish-subscribe model, where the first node publishes data on a channel in which the second node can subscribe. In such embodiments, the first node can store data in memory (e.g., memory 120 or some local memory of processor subsystem 110) and notify the second node that the data has been stored in the memory. In some embodiments, the first node notifies the second node that the data has been stored in the memory by sending a pointer (e.g., a memory pointer, such as an identification of a memory location) to the second node so that the second node can access the data from where the first node stored the data. In some embodiments, the first node would send the data directly to the second node so that the second node would not need to access a memory based on data received from the first node.

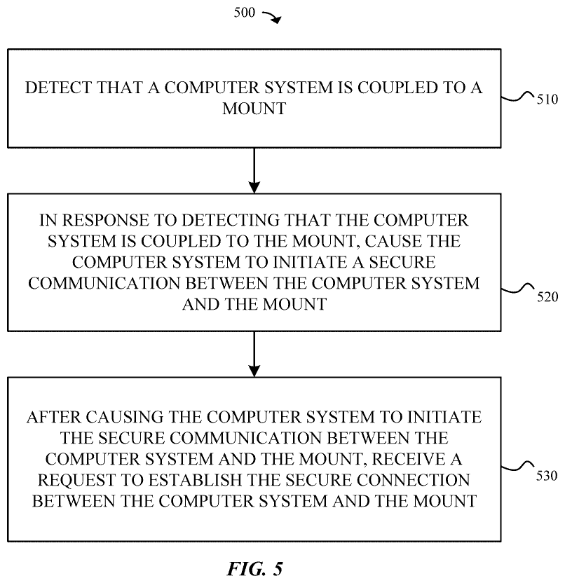

Memory 120 can include a computer readable medium (e.g., non-transitory or transitory computer readable medium) usable to store (e.g., configured to store, assigned to store, and/or that stores) program instructions executable by processor subsystem 110 to cause compute system 100 to perform various operations described herein. For example, memory 120 can store program instructions to implement the functionality associated with processes 500, 800, and 900 (FIGS. 5, 8, and 9) described below.

Memory 120 can be implemented using different physical, non-transitory memory media, such as hard disk storage, floppy disk storage, removable disk storage, flash memory, random access memory (RAM-SRAM, EDO RAM, SDRAM, DDR SDRAM, RAMBUS RAM, or the like), read only memory (PROM, EEPROM, or the like), or the like. Memory in compute system 100 is not limited to primary storage such as memory 120. Compute system 100 can also include other forms of storage such as cache memory in processor subsystem 110 and secondary storage on I/O device 140 (e.g., a hard drive, storage array, etc.). In some embodiments, these other forms of storage can also store program instructions executable by processor subsystem 110 to perform operations described herein. In some embodiments, processor subsystem 110 (or each processor within processor subsystem 110) contains a cache or other form of on-board memory.

I/O interface 130 can be any of various types of interfaces configured to communicate with other devices. In some embodiments, I/O interface 130 includes a bridge chip (e.g., Southbridge) from a front-side bus to one or more back-side buses. I/O interface 130 can communicate with one or more I/O devices (e.g., I/O device 140) via one or more corresponding buses or other interfaces. Examples of I/O devices include storage devices (hard drive, optical drive, removable flash drive, storage array, SAN, or their associated controller), network interface devices (e.g., to a local or wide-area network), sensor devices (e.g., camera, radar, LiDAR, ultrasonic sensor, GPS, inertial measurement device, or the like), and auditory or visual output devices (e.g., speaker, light, screen, projector, or the like). In some embodiments, compute system 100 is communicating with a network via a network interface device (e.g., configured to communicate over Wi-Fi, Bluetooth, Ethernet, or the like). In some embodiments, compute system 100 is directly or wired to the network.

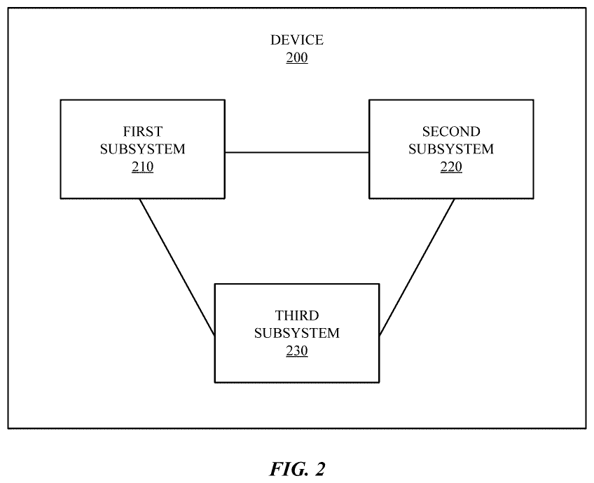

FIG. 2 illustrates a block diagram of device 200 with interconnected subsystems. In the illustrated example, device 200 includes three different subsystems (i.e., first subsystem 210, second subsystem 220, and third subsystem 230) communicating with (e.g., wired or wirelessly) each other, creating a network (e.g., a personal area network, a local area network, a wireless local area network, a metropolitan area network, a wide area network, a storage area network, a virtual private network, an enterprise internal private network, a campus area network, a system area network, and/or a controller area network). An example of a possible computer architecture of a subsystem as included in FIG. 2 is described in FIG. 1 (i.e., compute system 100). Although three subsystems are shown in FIG. 2, device 200 can include more or fewer subsystems.

In some embodiments, some subsystems are not connected to other subsystem (e.g., first subsystem 210 can be connected to second subsystem 220 and third subsystem 230 but second subsystem 220 cannot be connected to third subsystem 230). In some embodiments, some subsystems are connected via one or more wires while other subsystems are wirelessly connected. In some embodiments, messages are set between the first subsystem 210, second subsystem 220, and third subsystem 230, such that when a respective subsystem sends a message the other subsystems receive the message (e.g., via a wire and/or a bus). In some embodiments, one or more subsystems are wirelessly connected to one or more compute systems outside of device 200, such as a server system. In such embodiments, the subsystem can be configured to communicate wirelessly to the one or more compute systems outside of device 200.

In some embodiments, device 200 includes a housing that fully or partially encloses subsystems 210-230. Examples of device 200 include a home-appliance device (e.g., a refrigerator or an air conditioning system), a robot (e.g., a robotic arm or a robotic vacuum), and a vehicle. In some embodiments, device 200 is configured to navigate (with or without user input) in a physical environment.

In some embodiments, one or more subsystems of device 200 are used to control, manage, and/or receive data from one or more other subsystems of device 200 and/or one or more compute systems remote from device 200. For example, first subsystem 210 and second subsystem 220 can each be a camera that captures images, and third subsystem 230 can use the captured images for decision making. In some embodiments, at least a portion of device 200 functions as a distributed compute system. For example, a task can be split into different portions, where a first portion is executed by first subsystem 210 and a second portion is executed by second subsystem 220.

Attention is now directed to connecting devices. Such techniques are described in the context of a phone connecting with a mount. It should be recognized that other types of devices can be used with techniques described herein. For example, a keycard can connect with a door lock to transfer authentication information from the keycard to the door lock. In addition, techniques optionally complement or replace other techniques for connecting devices.

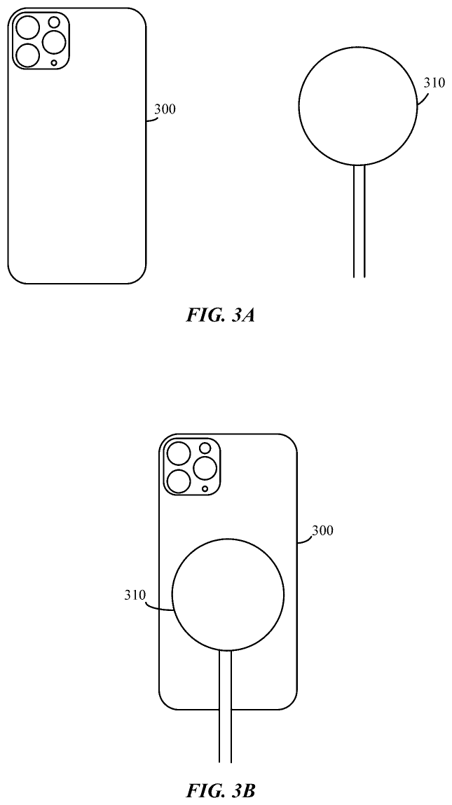

FIG. 3A is a block diagram illustrating phone 300 and mount 310. In some embodiments, phone 300 is an electronic device (and/or computer system), such as a user device (e.g., a smartphone, a smartwatch, a wearable device, a tablet, a fitness tracking device, a laptop computer, a vehicle, and/or a desktop computer). In such embodiments, phone 300 executes one or more software applications for providing functionality to a user of phone 300. In some embodiments, mount 310 is another electronic device, such as a charger (e.g., a device configured to charge another device such as phone 300), a case (e.g., a device configured to at least partially cover phone 300), a motorized stand, a vehicle, or a keycard.

In some embodiments, phone 300 and mount 310 each include one or more communication components for communicating with the other. In such embodiments, phone 300 and/or mount 310 can include one or more antennas for communicating using radio waves. In some embodiments, phone 300 includes a Radio Frequency Identification (RFID) reader (e.g., a Near-Field Communication (NFC) reader) to communicate with an RFID tag (e.g., a NFC tag) included with mount 310. In such embodiments, both phone 300 and mount 310 also includes a hardware transceiver for communicating using a wireless technology such as Bluetooth or Wi-Fi. In these examples, phone 300 can receive communications from mount 310 using the RFID reader and both devices can communicate using their respective hardware transceiver.

In some embodiments, phone 300 and mount 310 each include components to facilitate charging (e.g., wired or wireless charging) of phone 300 via mount 310. For example, phone 300 can include a primary coil and mount 310 can include a secondary coil. The primary coil is configured to generate an alternating current to create an electromagnetic field around the primary coil. The electromagnetic field causes the secondary coil to generate an electric current when in proximity to the primary coil. After the electric current is generated, phone 300 (e.g., a circuit of phone 300) is configured to convert the electric current into direct current to charge a power source of phone 300. In some embodiments, charging of phone 300 occurs in response to mount 310 detecting that phone 300 is coupled to mount 310. In other examples, charging of phone 300 occurs in response to mount 310 establishing a secure communication with phone 300.

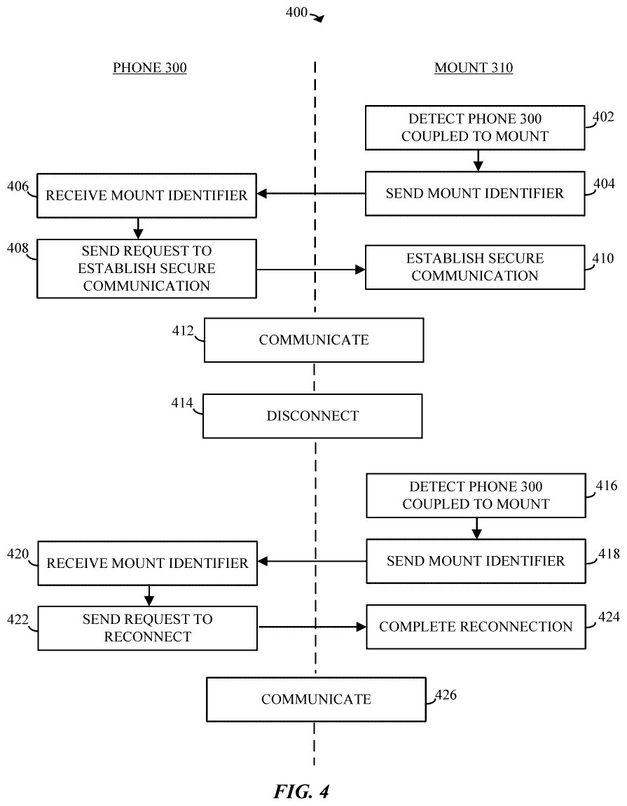

In FIG. 3A, phone 300 is not coupled to mount 310. Instead, phone 300 is able to be moved independent of mount 310 without needing to decouple from mount 310. While not coupled to mount 310 and before establishing a secure communication with mount 310, phone 300, in some embodiments, is not receiving communications from mount 310. In such embodiments, phone 300 only begins receiving communications from mount 310 once phone 300 is coupled to mount 310, as further discussed below with respect to FIG. 3B and the flow diagrams in FIGS. 4 and 5.

FIG. 3B is a block diagram illustrating mount 310 coupled to phone 320. In some embodiments, the coupling is temporary such that mount 310 and/or phone 320 is able to decouple and recouple. Examples of temporary coupling mechanisms include magnets, movable and/or flexible physical components to hold devices together, male/female couplers, adhesive, and/or physical proximity. In some embodiments, when mount 310 is coupled to phone 320, one or more operations described herein are initiated, including the operations described in FIGS. 4 and 5 below.

FIG. 4 is a flow diagram illustrating operations performed by phone 300 (e.g., phone 300 from FIGS. 3A-3B) and mount 310 (e.g., mount 310 from FIGS. 3A-3B) before, during, and after establishing a secure communication. The operations in FIG. 4 (referred to as flow 400) are, optionally, combined, the orders of some operations are, optionally, changed, and some operations are, optionally, omitted.

At 402, flow 400 includes mount 310 detecting that phone 300 is coupled to mount 310. In some embodiments, a RFID reader of phone 300 generates a magnetic field by passing an electric current through a coil. The magnetic field then induces an electric current within an RFID tag of mount 310 and thereby causing mount 310 to detect that phone 300 is coupled to mount 310 (e.g., by the fact that mount 310 is provided power and is activated). In other examples, phone 300 detects that the two devices are coupled and sends a message to mount 310 to indicate that the two devices are coupled. In such embodiments, receiving the message by mount 310 serves as mount 310 detecting that phone 300 is coupled to mount 310. In other examples, the coupling of phone 300 and mount 310 causes a state of a physical component of mount 310 to be modified (e.g., a physical button to be pressed or an electrical connection be made or broken), indicating that mount 310 is coupled to something else and serving as mount 310 detecting that phone 300 is coupled to mount 310. It should be recognized that mount 310 can detect that phone 300 is coupled to mount 310 in other ways known to a person of ordinary skill in the art and that such detection is a trigger for other operations to occur as discussed below.

At 404, flow 400 includes mount 310 sending a mount identifier to phone 300. In some embodiments, the mount identifier includes identification information of mount 310 such that phone 300 is able to distinguish phone 300 from another device. In such embodiments, the mount identifier is unique and/or predefined for mount 310. In other examples, the mount identifier can be assigned to mount 310 by phone 300. In either set of examples, the mount identifier is one or more bits that are optionally randomized. To continue an example described above, the mount identifier is stored in the RFID tag of mount 310 and be wirelessly transmitted to the RFID reader of phone 300 after the magnetic field induces an electric current with the RFID tag. For another example, the mount identifier is received from phone 300 during a previous connection and be used as the mount identifier when connecting with phone 300 specifically.

At 406, flow 400 includes phone 300 receiving the mount identifier from mount 310. In some embodiments, the mount identifier is received by phone 300 via a specific wireless technology (e.g., NFC, Bluetooth, or Wi-Fi). Then, at 408, flow 400 includes phone 300 sending a request to establish a secure communication with mount 310. While illustrated as coming from phone 300, it should be recognized that the request can come from mount 310 to phone 300. In some embodiments, the request is sent via the same wireless technology as used to receive the mount identifier (in some embodiments, the message with the mount identifier serves as the request to establish the secure communication). In other examples, the request is sent via a different wireless technology, such as the wireless technology that is used for the secure communication. In either set of examples, the wireless technology for the secure communication is different from the wireless technology used to transmit the mount identifier (e.g., the wireless technology for the secure communication can have a larger range than the wireless technology used to transmit the mount identifier). In some embodiments, the request is a request to establish a pairing between phone 300 and mount 310, such as a Bluetooth pairing. In such embodiments, the request can include a code that is used by at least one of the devices to communicate with the other securely.

At 410, flow 400 includes mount 310 establishing a secure communication with phone 300. It should be recognized that either device can establish the secure communication and that 410 is illustrating that the secure communication has been established. In some embodiments, establishing the secure communication includes establishing a code or set of keys to use when communicating between the devices. In such embodiments, the code or set of keys can be used to encrypt and/or decrypt a communication. After establishing the secure communication, phone 300 and mount 310 can communicate between each other, as illustrated as 412, until the secure communication is disconnected and/or phone 300 is no longer coupled to mount 310.

After 410 and at 414, flow 400 includes the secure communication between phone 300 and mount 310 disconnecting. In some embodiments, one of the devices can initiate the disconnection. For example, phone 300 and/or mount 310 can detect that phone 300 is no longer coupled to mount 310 and, in response, cause the secure communication to be terminated. In other examples, the secure communication between phone 300 and mount 310 is disconnected without either device explicitly causing the secure communication to be disconnected, such as due to signal strength or interference.

At 416, similar or the same as 402, mount 310 detects that phone 300 is coupled to mount 310. In response to detecting that phone 300 is coupled to mount 310, mount 310, at 418, sends a mount identifier to phone 300 (similar or the same as 404) and, at 420, phone 300 receives the mount identifier (similar or the same as 406).

After receiving the mount identifier, phone 300, in some embodiments, determines whether phone 300 has information to reestablish a secure communication with mount 310. For example, phone 300 can store a code or key used to communicate with mount 310 such that phone 300 does not need to establish a new code or key for secure communication with mount 310. In such embodiments, when phone has information to reestablish the secure communication, at 422, phone 300 sends a request to reconnect to mount 310. In some embodiments, the request includes data needed to reconnect the secure communication, such as a previously established code or key. In other examples, no request is sent, and phone 300 proceeds to communicating with mount 310 through a secure communication after receiving the mount identifier.

At 424, after sending the request at 422, mount 310 receives the request and completes reconnection. It should be recognized that either device can reestablish the secure communication and that 424 is illustrating that the secure communication has been reestablished. After reestablishing the secure communication, phone 300 and mount 310 are able to communicate between each other, as illustrated in 426, until the secure communication is disconnected and/or phone 300 is no longer coupled to mount 310.

FIG. 5 is a flow diagram illustrating process 500 for detecting data using different sensors. Some operations in process 500 are, optionally, combined, the orders of some operations are, optionally, changed, and some operations are, optionally, omitted. In some embodiments, process 500 is performed by a compute system (e.g., compute system 100) or a computer system (e.g., device 200). In some embodiments, process 500 is performed by a computer system (e.g., an electronic device, such as a user device or an electronic mount). In some embodiments, the electronic device is coupled (e.g., physically (e.g., wired) or magnetically) to the user device.

At 510, process 500 includes detecting that a computer system (e.g., a user device) is coupled (e.g., physically (e.g., wired) or magnetically) to a mount.

At 520, process 500 includes: in response to detecting that the computer system is

coupled to the mount, causing the computer system to initiate a secure communication (e.g., a wireless connection) between the computer system and the mount, wherein such causing includes sending a message via a first type of communication channel (e.g., NFC) to the computer system, and wherein the message includes an identifier of the mount.

At 530, process 500 includes: after causing the computer system to initiate the secure communication between the computer system and the mount, receiving, via a second type of communication channel different from the first type of communication channel (e.g., Bluetooth) (in some embodiments, the second type of communication channel is a two-way communication channel, wherein the computer system communicates with the mount using the second type of communication channel, and wherein the mount communicated with the computer system using the second type of communication channel), a request to establish the secure communication (in some embodiments, the secure communication is secured using a secret code) between the computer system and the mount (in some embodiments, the request is processed such that the mount connects with the computer system).

In some embodiments, the first type of communication channel uses Near Field Communication (NFC), wherein the second type of communication channel uses a short-range technology (in some embodiments, the second type of communication channel uses a short-range technology, such as Bluetooth). In some embodiments, process 500 includes: in response to detecting that the computer system is coupled to the mount, initiating charge of the computer system. In some embodiments, the request to establish the secure communication includes a request to pair the mount with the computer system.

In some embodiments, the request to establish the secure communication includes a request to reestablish the secure communication using pairing information established before detecting that the computer system is coupled to the mount (in some embodiments, the secure communication between the mount and the computer system has been disconnected before receiving the request to establish the secure communication).

In some embodiments, process 500 includes: in response to determining that the computer system is uncoupled (and/or decoupled) from the mount, disconnecting (e.g., by the computer system or the mount) the secure communication between the computer system and the mount. In some embodiments, detecting that the computer system is coupled to the mount includes identifying that the computer system is magnetically coupled to the mount.

Attention is now directed towards techniques for communicating between devices. Such techniques are described in the context of a phone communicating with another device while the phone is attached to a mount. It should be recognized that other types of electronic devices can be used with techniques described herein. For example, a standalone camera and/or a smart display can be controlled using techniques described herein. In addition, techniques optionally complement or replace other techniques for communicating between devices.

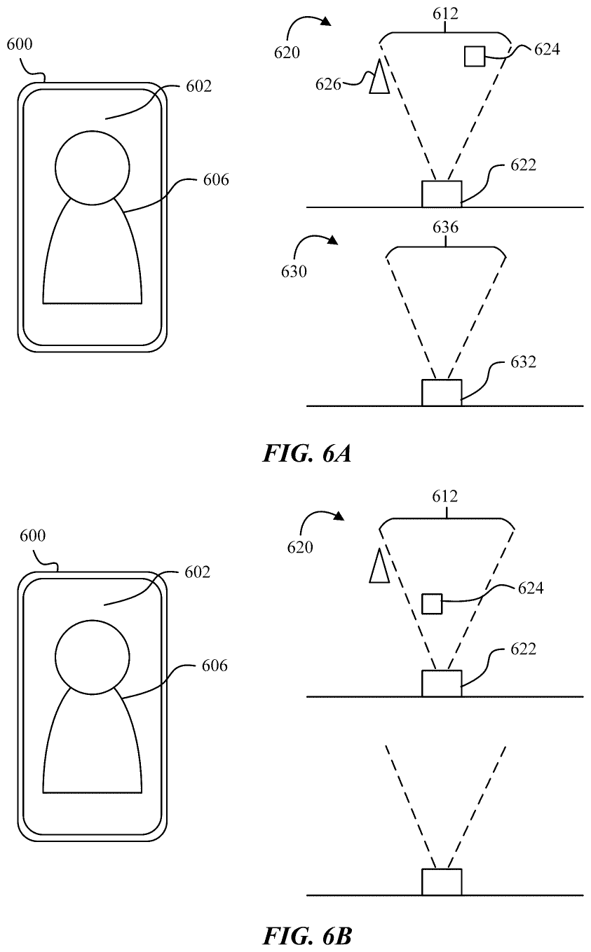

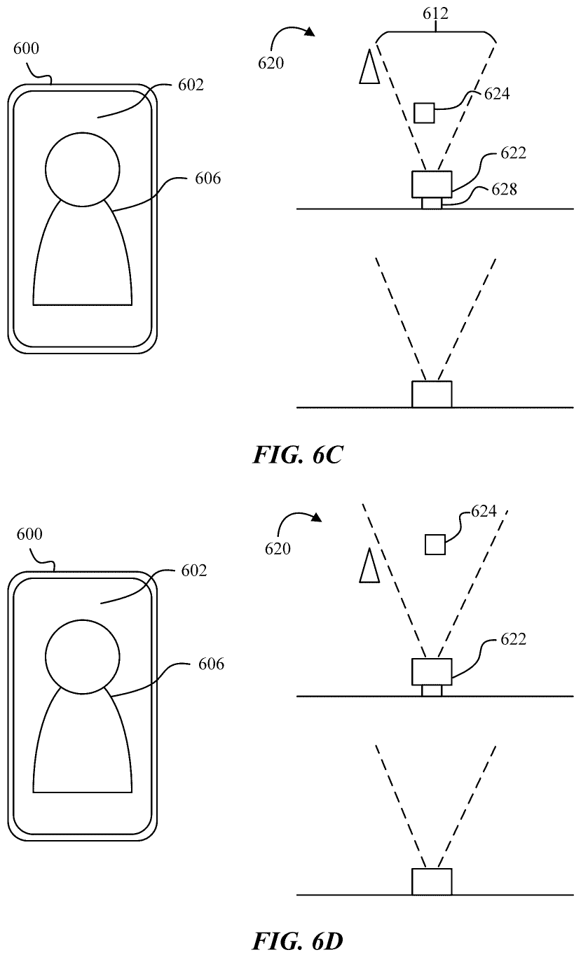

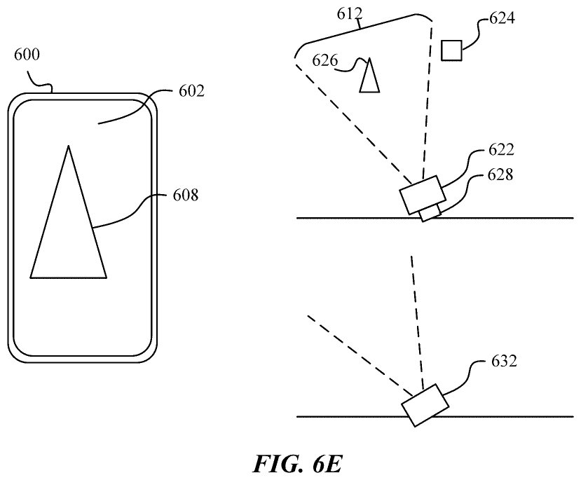

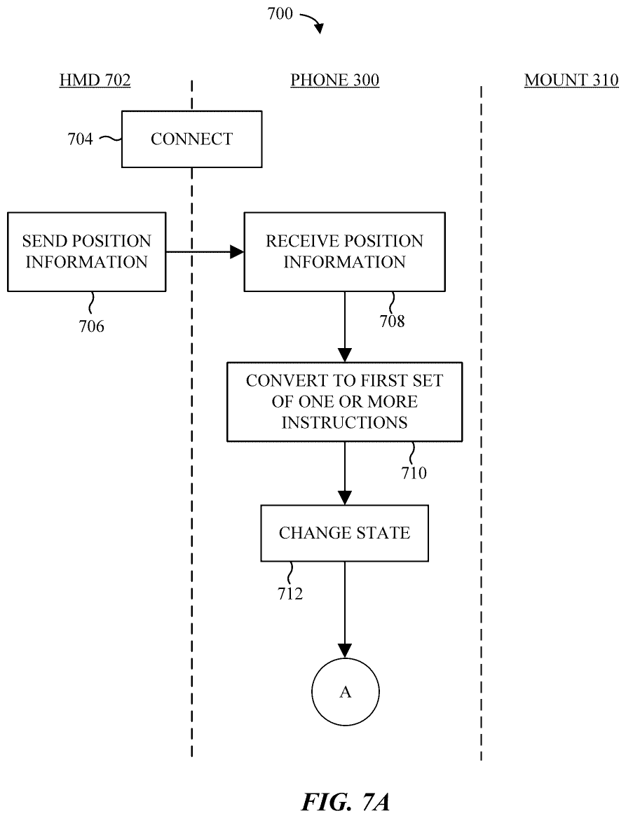

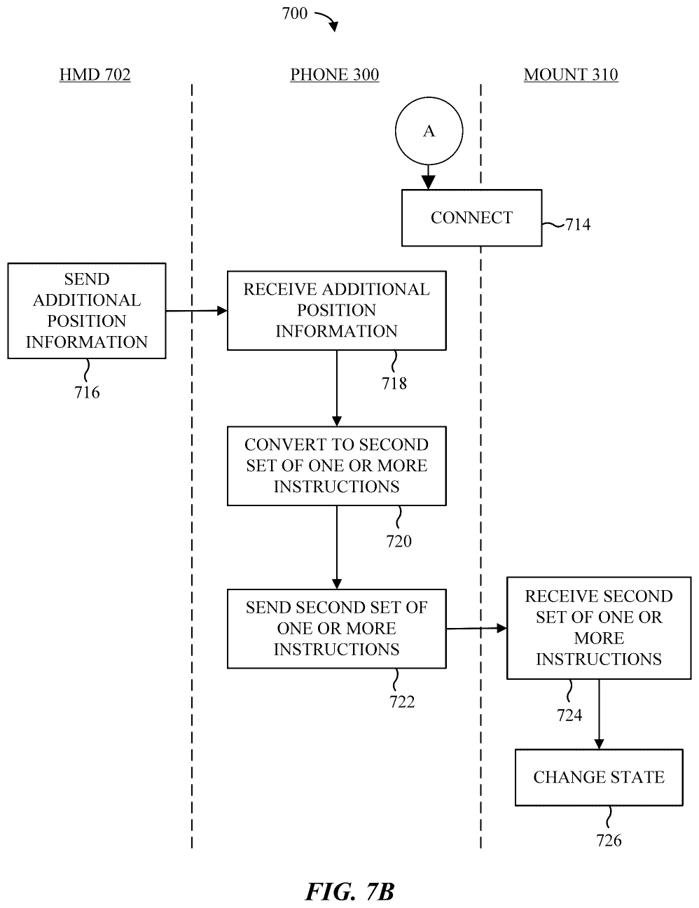

FIGS. 6A-6E illustrate exemplary user interfaces for displaying a view of an environment in accordance with some embodiments. The user interface in these figures are used to illustrate the processes described below, including the processes in FIGS. 7A-7B, 8, and 9.

The left side of FIGS. 6A-6E illustrate first computer system 600 as a smart phone. It should be recognized that first computer system 600 can be other types of computer systems, such as a tablet, a smart watch, a laptop, communal device, a smart speaker, a personal gaming system, a desktop computer, a fitness tracking device, and/or a HMD device. In some embodiments, first computer system 600 includes and/or is in communication with one or more input devices (e.g., a camera, a depth sensor, a microphone, a hardware input mechanism, a rotatable input mechanism, a heart monitor, a temperature sensor, and/or a touch-sensitive surface). In some embodiments, first computer system 600 includes and/or is in communication with one or more output devices (e.g., a display generation component (e.g., a display screen, a projector, and/or a touch-sensitive display), an audio generation component (e.g., smart speaker, home theater system, soundbar, headphone, carphone, carbud, speaker, television speaker, augmented reality headset speaker, audio jack, optical audio output, Bluetooth audio output, and/or HDMI audio output), a speaker, a haptic output device, a display screen, a projector, and/or a touch-sensitive display)). In some embodiments, first computer system 600 is a personal device of a user and/or associated with an account of the user. As illustrated in FIGS. 6A-6E, first computer system 600 displays live view 602 of a physical environment. In some embodiments, live view 602 includes media (e.g., an image and/or video) captured by one or more cameras of first computer system 600 and/or another computer system (e.g., a second computer system as described below).

The bottom right side of FIGS. 6A-6E illustrate different positions of first computer system 600 within physical environment 630. Physical environment 630 includes device representation 632, which represents first computer system 600. As illustrated in FIGS. 6A-6E, physical environment 630 also includes field of view 636, which indicates an orientation of first computer system 600 within physical environment 630 and/or a field of view of one or more cameras of the second computer system.

The top right side of FIGS. 6A-6E illustrate different positions of a second computer system within physical environment 620. It should be recognized that physical environment 620 can be different from physical environment 630. For example, physical environment 620 can be a different room, city, and/or country than physical environment 630. As illustrated in FIGS. 6A-6E, physical environment 620 includes device representation 622 for the second computer system, user 624, and object 626. At FIGS. 6A-6E, positions of device representation 622, user 624, and object 626 within physical environment 620 represent the real-world position of the second computer system with respect to user 624 and object 626. In some embodiments, additional users and/or objects are in physical environment 620. As illustrated in FIGS. 6A-6E, physical environment 620 also includes field of view 612, which indicates an orientation of the second computer system within physical environment 620 and/or a field of view of one or more cameras of the second computer system. In some embodiments, and as described below, the portion of physical environment 620 within field of view 612 are represented in live view 602.

The below description of FIGS. 6A-6E describe the second computer system as a smart phone. It should be recognized that the second computer system can be other types of computer systems and/or includes and/or be in communication with one or more devices and/or components as described above with respect to first computer system 600. In some embodiments, the second computer system is different from first computer system 600. For example, the second computer system is a HMD device and first computer system 600 is a phone. In some embodiments, the second computer system is a personal device of a user and/or associated with an account of the user. In some embodiments, the second computer system is a personal device of a user different from the user of first computer system 600. In some embodiments, the second computer system is associated with an account of a user different from the user of first computer system 600.

At FIGS. 6A-6E, first computer system 600 (e.g., as represented by device representation 632) and the second computer system (e.g., as represented by device representation 622) are in communication, such as in a video call. For example, first computer system 600 can have called the second computer system to initiate the video call described below with respect to FIGS. 6A-6E. It should be recognized that, in some embodiments, more computer systems and/or computer systems of the same user can be in the video call.

At FIGS. 6A-6E, during the video call, the second computer system sends media captured by one or more cameras of the second computer system to first computer system 600. In some embodiments, the media includes image(s) and/or video(s) of a portion of physical environment 620 in field of view 612. For example, the second computer system can send a portion of physical environment 620 in field of view 612 that includes user 624. At FIGS. 6A-6E, first computer system 600 displays the portion of physical environment 620 being sent by the second computer system. It should be recognized that first computer system 600 and/or the second computer system can display the same, similar, and/or different content. For example, first computer system 600 can display a representation of field of view 612 while displaying a representation of field of view 636. Similarly, the second computer system can display a representation of field of view 612 (e.g., captured by one or more cameras of first computer system 600) and/or a representation of field of view 636 (e.g., captured by the second computer system).

In some embodiments, the second computer system displays live view 602 as a preview to user 624 in physical environment 620, showing the environment it captures. In some embodiments, the second computer system displays live view 602 while first computer system 600 displays live view 602. In some embodiments, only the second computer system displays live view 602 (e.g., and not first computer system 600). The second computer system displaying live view 602 can inform user 624 that the second computer system is capturing them. In some embodiments, the second computer system is used by a second user (e.g., different from user 624) and the second computer system displays live view 602 to provide the second user an indication of what they are sending to first computer system 600.

Turning to FIGS. 6A-6B, the second computer system is not coupled to a mount (e.g., mount 628 described below at FIGS. 6C-6E). In some embodiments, while not coupled to a mount, the second computer system cannot physically change orientation and/or direction to capture different portions of physical environment 620. In such embodiments, if user 624 moves outside of field of view 612, the second computer system will not and cannot move to follow the user because it is not coupled to a mount.

FIGS. 6A-6B describe how the second computer system can adjust the image it sends to first computer system 600 using a hardware and/or software zoom to maintain a view of user 624 without physically moving a position of the second computer system. By adjusting the image to maintain a view of user 624 (or any other object or subject), the second computer system provides the effect of appearing to physically move (e.g., to first computer system 600) to maintain the distance from user 624 without any requirement to physically move. From the perspective of live view 602 of the first computer system, user 624 moves but is displayed at the same relative size in the media received from the second computer system.

Turning to FIG. 6A, while on the video call, the second computer system sends the portion of physical environment 620 in field of view 612 to first computer system 600. As illustrated in FIG. 6A, user 624 is in field of view 612 in physical environment 620. At FIG. 6A, the second computer system sends the portion of physical environment 620 to first computer system 600. As illustrated in FIG. 6A, first computer system 600 displays the portion of physical environment 620 in live view 602 (e.g., including representation 606 of user 624).

As illustrated in FIG. 6B, while on the video call, user 624 moved closer to the second computer system in physical environment 620, as shown by the reduced distance from device representation 622 compared to FIG. 6A. At FIG. 6B, after user 624 moved closer, the second computer system captures media that includes user 624 closer to it. For example, capturing media that includes user 624 closer to the second computer system includes capturing an image of user 624 larger than in the media in FIG. 6A. However, in this example, although user 624 moved closer to the second computer system in FIG. 6B, representation 606 of user 624 in live view 602 in FIG. 6B is the same size in comparison to representation 606 of user 624 in live view 602 in FIG. 6A.

In some embodiments, representation 606 of user 624 is the same size in live view 602 in FIG. 6A and FIG. 6B as a result of first computer system 600 or the second computer system altering the media sent or received. For example, at FIG. 6B, while on the video call, the second computer system sends media of the portion of physical environment 620 in field of view 612 to first computer system 600. However, in this example, instead of the second computer system sending the media (e.g., as captured, with user 624 larger than was captured in FIG. 6A), at FIG. 6B the second computer system digitally zooms out of the media to maintain the respective size of user 624 in the media (e.g., compared to the size sent in the media at FIG. 6A), and sends media of the portion of physical environment 620 in field of view 612 to first computer system 600. In another example, at FIG. 6B, while on the video call, the second computer system adjusts the zoom of one or more cameras to maintain the respective size of user 624 in the media (e.g., compared to the size sent in the media at FIG. 6A), and sends media of the portion of physical environment 620 in field of view 612 to first computer system 600. In some embodiments, first computer system 600 displays representation 606 of user 624 in the same relative size as displayed in FIG. 6A by cropping and/or zooming out from the media throughout the movement of user 624. In some embodiments, the second computer system digitally zooms and/or adjusts the zoom of one or more cameras out from the media for the entirety of the movement of user 624 to maintain the same relative size of user 624 in the media when displayed by the first computer system in comparison to the size of user 624 in the media in FIG. 6A.

Turning to FIGS. 6C-6E, the second computer system is coupled to mount 628, as represented by device representation 622 adjacent to mount 628. In some embodiments, mount 628 is mount 310 as described above with respect to FIGS. 3A-3B, 4, and 5. In some embodiments, mount 628 can move physically, and movement of mount 628 moves the second computer system. In some embodiments, moving mount 628 changes field of view 612.

At FIGS. 6C-6E, the second computer system is configured to cause mount 628 to mirror the movement of first computer system 600. In some embodiments, mount 628 does not communicate directly with first computer system 600 but rather the second computer system communicates with mount 628. In some embodiments, the second computer system receives position information from first computer system 600 and the second computer system determines changes (if any) that need to be made by the media captured by the second computer system and/or mount 628. In some embodiments, the second computer system determines the second computer system needs to zoom in on the media (e.g., digitally zoom and/or adjust the zoom of one or more cameras, as described above at FIG. 6B). In some embodiments, the second computer system determines the second computer system needs to send movement instructions to mount 628 to move the second computer system in order to move the second computer system and change the orientation of field of view 612 of the one or more cameras.

In some embodiments, coupling the second computer system to mount 628 configures the second computer system to operate in a particular mode and/or state. For example, coupling the second computer system to mount 628 can initiate the second computer system to communicate with mount 628 (e.g., as described above with respect to FIGS. 3A-3B, 4, and 5). In some embodiments, coupling the second computer system to mount 628 initiates the second computer system to send movement instructions to mount 628 to mirror the movement of first computer system 600. In such embodiments, while the second computer system is not coupled to mount 628, the second computer system does not send movement instructions to mount 628 in order to move.

FIGS. 6C-6D describe how, despite being coupled to mount 628, the second computer system can adjust the media it sends to first computer system 600 to display a view of user 624 in the same size of the media with or without physically moving the second computer system or mount 628. At FIGS. 6C-6D, this functionality is the same functionality available when not mounted (e.g., as described above at FIGS. 6A-6B).

As illustrated in FIG. 6C, while on the video call, the second computer system sends the portion of physical environment 620 in field of view 612 to first computer system 600. As illustrated in FIG. 6C, user 624 is near the second computer system (e.g., as illustrated by device representation 622 being in close proximity to user 624 in physical environment 620) and within field of view 612. At FIG. 6C, the second computer system sends the portion of physical environment 620 to first computer system 600. As illustrated in FIG. 6C, first computer system 600 displays the portion of physical environment 620 in live view 602 (e.g., including representation 606 of user 624).

As illustrated in FIG. 6D, while on the video call, user 624 moved farther away from the second computer system, as represented by the distance from device representation 622 in physical environment 620 being larger than as illustrated in FIG. 6C. At FIG. 6D, although user 624 moved further from the second computer system, first computer system 600 displays representation 606 of user 624 at the same size in comparison to representation 606 of user 624 at FIG. 6C. For example, capturing media that includes user 624 further from the second computer system includes capturing an image of user 624 smaller than in the media in FIG. 6C. However, in this example, although user 624 moved (e.g., from the location illustrated in FIG. 6C) further from the second computer system (e.g., as illustrated in FIG. 6D), representation 606 of user 624 in live view 602 in FIG. 6D is the same size in comparison to representation 606 of user 624 in live view 602 in FIG. 6C. In some embodiments, representation 606 of user 624 is the same size in live view 602 in FIG. 6D and FIG. 6C as a result of first computer system 600 or the second computer system altering the media sent or received as described above with respect to FIG. 6B.

Turning to FIG. 6E, while on the video call, first computer system 600 is rotated to the left, as illustrated in the bottom right side of FIG. 6E. In some embodiments, while and/or after being rotated, first computer system 600 causes the second computer system to rotate (e.g., to mirror movement of first computer system 600), as illustrated in the top right side of FIG. 6E. In some embodiments, such rotation of the second computer system is caused via mount 628 by mount 628 being rotated while coupled to the second computer system, as further discussed below.

As illustrated in FIG. 6E, while on the video call, first computer system 600 changed live view 602 to include representation 608 of object 626 instead of representation 606 of user 624 (e.g., as illustrated in FIG. 6D). At FIG. 6E, in response to mount 628 moving the second computer system, the orientation of field of view 612 changed orientation (from FIG. 6D) to include object 626 within field of view 612. As illustrated in FIG. 6E, user 624 is no longer within field of view 612. At FIG. 6E, the second computer system captures the media including a portion of the field of view 612 and sends the media to first computer system 600. At FIG. 6E, in response to receiving the media from the second computer system, first computer system 600 displays the media (e.g., including representation 608 of object 626 and not including representation 606 of user 624) in live view 602.

FIGS. 7A-7B illustrate an exemplary communication diagram for two computer systems and a mount in accordance with some embodiments. As illustrated in FIGS. 7A-7B, the two computer systems and the mount communicate according to diagram 700. It should be recognized that such computer systems and/or the mount can communicate differently than illustrated, including more, fewer, and/or different communications and/or in a different order.

As illustrated in FIGS. 7A-7B, diagram 700 includes HMD 702, phone 300, and mount 310. HMD 702 represents a head mounted display (HMD) device, such as first computer system 600 in FIGS. 6A-6E. Phone 300 represents a phone, such as the second computer system in FIGS. 6A-6E. Mount 310 represents a mount, such as a described above with respect to mount 628 in FIGS. 6A-6E.

FIGS. 7A-7B illustrate a diagram of HMD 702, phone 300, and mount 310 communicating during a video call. In some embodiments, the video call of diagram 700 is similar to the video call described above with respect to FIGS. 6A-6E.

At 704, HMD 702 and phone 300 connect to establish the video call. In some embodiments, HMD 702 and phone 300 connect via one or more channels and/or technologies (e.g., cellular and/or Wi-Fi). In some embodiments, HMD 702 called phone 300 via a calling application. In such embodiments, the different user accepts the video call and HMD 702 and phone 300 connect to exchange video and/or audio data of each device.

At 706 and 708, after HMD 702 and phone 300 connect to establish the video call, HMD 702 sends position information of HMD 702 to phone 300 and phone 300 receives the position information from HMD 702. In some embodiments, the position information is sent by HMD 702 via the same channel and/or embed within the video call. In some embodiments, the position information includes a position of HMD 702 in a physical environment. Referring to FIGS. 6A-6E, the position information of 706 and 708 can include the position of first computer system 600 as represented by device representation 632 in physical environment 630.

At 710, while on the video call, phone 300 converts the position information to a first set of one or more instructions for phone 300. In some embodiments, the first set of one or more instructions includes instructions for operations to be performed by phone 300 to control an input and/or output (I/O) component of phone 300 (e.g., a camera, movement component, and/or display). In some embodiments, the first set of one or more instructions include digital operations (e.g., crop and/or zoom) to simulate physical movements. In FIGS. 6A-6B, the first set of one or more instructions include instructions to zoom out of the media in order to simulate the movement of the second computer system moving to keep the same relative distance from user 624 in physical environment 620. In some embodiments, the first set of one or more instructions include instructions to translate, move, and/or rotate a component of phone 300.

In some embodiments, HMD 702 includes more degrees of freedom of movement than phone 300 and phone 300 simulates the movement of HMD 702 by simulating the movement with the freedom of movement available. In some embodiments, the degrees of freedom of movement include the number of movements and/or the degree of the movements. For example, HMD 702 can include three degrees of freedom of movement in a physical environment, including forward and backward, left and right, and up and down. In such an example, phone 300 can include two degrees of freedom of movement in a physical environment including forward and backward and left and right. In some embodiments, HMD 702 includes more degrees of freedom of movement because HMD 702 can be worn and physically moved around the room while phone 300 is coupled to and/or includes a mechanism (e.g., a more limited mechanism that only rotates) to move independently.

In some embodiments, phone 300 converting the position information to the first set of one or more instructions includes changing the position information from HMD 702 with three degrees of freedom of movement to a position achievable by the two degrees of freedom of movement of phone 300. For example, the position information from HMD 702 can correspond to looking down, rotating left, and moving forward. In such an example, in response to detecting the position information from HMD 702 corresponding to looking down, rotating left and moving forward, the set of one or more instructions for phone 300 with two degrees of freedom of movement can include panning down, rotating left, and digitally zooming (e.g., to simulate the aspect of moving forward) the media. In some embodiments, converting the position information includes converting a degree (e.g., amount) of rotation of HMD 702 to a rotation degree achievably by phone 300. In some embodiments, as illustrated in FIGS. 6D-6E, while on the video call, first computer system 600 as represented by device representation 632 rotated slightly to the left by 20 degrees. In some embodiments, where the first computer system is not coupled to mount 628 and therefore cannot rotate, in response to detecting first computer system 600 rotated slightly to the left by 20 degrees, instead of rotating, the second computer system digitally zooms the media being captured of physical environment 620 to the left in order to simulate the movement of rotating by first computer system 600.

At 712, in response to converting the position information to the first set of one or more instructions, phone 300 changes state by performing the first set of one or more instructions. In some embodiments, the first set of one or more instructions include instructions to translate, move, and/or rotate a component of phone 300, and phone 300 performs the instructions by translating, moving, and/or rotating respectively. In some embodiments, as described above at FIG. 6B, the first set of one or more instructions includes instructions to digitally zoom media captured by the second computer system in physical environment 620, and the second computer system digitally zooms the media.

The exemplary communication diagram continues from FIG. 7A to FIG. 7B via the marker “A” as indicated on each respective figure. Continuing with FIG. 7B, diagram 700 continues from FIG. 7A.

At 714, phone 300 and mount 310 connect (e.g., during the video call). Such connection can occur as described above with respect to FIGS. 4-5. In some embodiments, mount 310 and phone 300 connect via one or more channels and/or technologies (e.g., Bluetooth, cellular, and/or Wi-Fi). In some embodiments, phone 300 and mount 310 connect differently than the connection established at 704. In some embodiments, in comparison to 704, where phone 300 and HMD 702 connect by one device accepting a video call from another device, phone 300 and mount 310 connect by physically coupling to one another (e.g., as described below), and/or by pairing the two devices together (e.g., via Bluetooth). In some embodiments, in comparison to 704, where phone 300 and HMD 702 connect by an intermediary service and/or device. (e.g., a cellular provider and/or server), phone 300 and mount 310 connect directly to one another (e.g., without an intermediary device and/or service).

In some embodiments, phone 300 determines mount 310 is coupled (and/or initiates a channel to communicate position information to mount 310) based on and/or in response to movement of phone 300 and mount 310, data received from mount 310, and/or a strength of a magnetic field from mount 310. For example, phone 300 can determine mount 310 is coupled based on a detected magnetic field strength, based on an NFC communication between phone 300 and mount 310, and/or a detected received signal strength indicator (RSSI strength) between phone 300 and mount 310. For another example, phone 300 determines phone 300 and mount 310 are coupled based on phone 300 receiving a message (e.g., from mount 310) indicating mount 310 and phone 300 are coupled. For another example, phone 300 determines phone 300 and mount 310 are coupled based movement of the phone 300 relative to mount 310. In such an example, phone 300 can determine that phone 300 and mount 310 are coupled when sensor data detected via separate inertial measurement units (IMUs) of each device matches a threshold amount and/or for a threshold amount of time.

At 716, after phone 300 and mount 310 connect, and during the video call, HMD 702 moves to a new location and sends additional position information of HMD 702 (e.g., a new position of HMD 702) to phone 300. At 718, after phone 300 and mount 310 connect, and during the video call, phone 300 receives the additional position information. In some embodiments, because the video call is ongoing, HMD 702 is streaming media content (e.g., content captured by HMD 702) to phone 300 while receiving the additional position information. In some embodiments, the additional position information of HMD 702 is embedded in the media (e.g., the video call) being sent to phone 300. In some embodiments, HMD 702 determines the position of HMD 702 using one or more cameras of HMD 702.

At 720, in response to receiving the additional position information, phone 300 converts the additional position information to a second set of one or more instructions. In some embodiments, the second set of one or more instructions at 720 are different from the first set of one or more instructions at 710. In some embodiments, converting the additional position information includes changing the additional position information into the second set of one or more instructions for mount 310. In some embodiments, the second set of one or more instructions include instructions to rotate and/or move mount 310 which moves phone 300.

In some embodiments, phone 300 converts the additional position to a third set of one or more instructions in addition to the second set of one or more instructions. In such embodiments, the third set of one or more instructions can be for phone 300, such as one or more operations to be performed by phone 300 instead of mount 310. Such operations can be the same or similar to as described above with respect to the first set of one or more instructions. For example, the third set of one or more instructions can include digital operations (e.g., crop and/or zoom) to simulate physical movements to be performed by phone 300. In such an example, phone 300 can perform a digital zoom in on a user while concurrently (and/or sequentially) causing mount 310 to physically move.

In some embodiments, comparing 710 to 720, phone 300 can convert the same or different position information differently. For example, in 710, phone 300 is not connected to mount 310 and phone 300 converts position information from HMD 702 into zooming and/or cropping the image while, in 710, phone 300 is connected to mount 310 and phone 300 converts position information into movements for mount 310.

At 722 and 724, after converting the additional position information to the second set of one or more instructions, phone 300 sends and mount 310 receives the second set of one or more instructions. As mentioned above, in some embodiments, the second set of one or more instructions is sent via a different communication mode than the communication mode used to receive the additional position information from HMD 702. For example, the second set of one or more instructions can be sent via a communication mode with a shorter range and/or lower power requirements than used to receive the additional position information (e.g., Bluetooth or NFC instead of cellular or Wi-Fi).

At 726, in response to receiving the second set of one or more instructions, mount 310 changes state. In some embodiments, mount 310 changes state by moving to achieve a new physical position. In some embodiments, mount 310 moves to the new position by executing the second set of one or more instructions.

In some embodiments, after mount 310 changes state and moves to the new position, phone 300 (coupled to mount 310) also moves and changes the field of view of one or more cameras of phone 300. In some embodiments, after changing the field of view of the one or more cameras, phone 300 sends media corresponding to the new field of view to HMD 702.

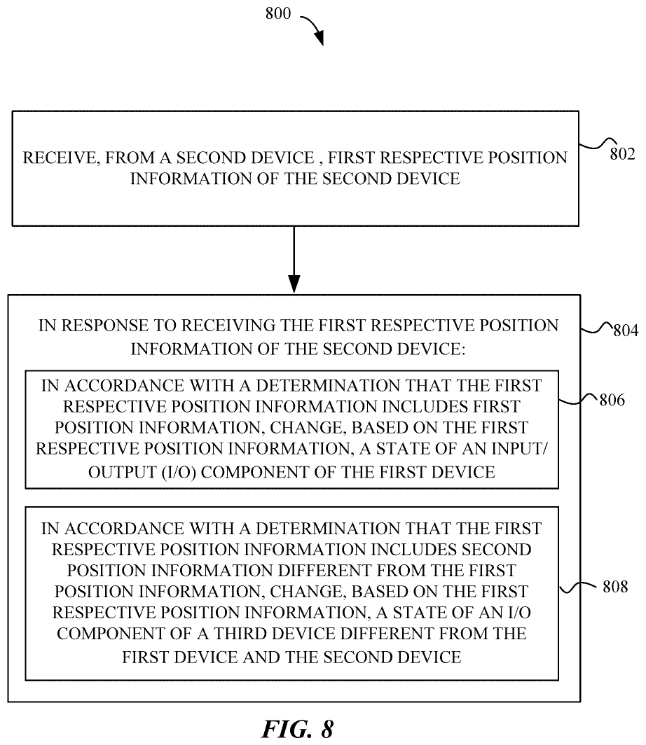

FIG. 8 is a flow diagram illustrating a method (e.g., process 800) for communicating between devices in accordance with some embodiments. Some operations in process 800 are, optionally, combined, the orders of some operations are, optionally, changed, and some operations are, optionally, omitted.

As described below, process 800 provides an intuitive way for communicating between devices. Process 800 reduces the cognitive burden on a user, thereby creating a more efficient human-machine interface. For battery-operated computing devices, enabling a user to interact with such devices faster and more efficiently conserves power and increases the time between battery charges.

In some embodiments, process 800 is performed at a first device (e.g., a computer system, a personal device, an accessory device, a controller device, a smart phone, a smart watch, a fitness tracking device, a tablet, a head-mounted display (HMD) device, a speaker, a smart light, a laptop, an electronic device, and/or another type of computer system).

The first device receives (802), from a second device (e.g., a computer system, a personal device, an accessory device, a controller device, a smart phone, a smart watch, a fitness tracking device, a tablet, a head-mounted display (HMD) device, a speaker, a smart light, a laptop, an electronic device, and/or another type of computer system) different from the first device, first respective position (e.g., orientation and/or location) information of the second device (e.g., a position in which a user of the second device wants to see with respect to a field of view of the first device).

In response to (804) receiving the first respective position information of the second device, in accordance with a determination that the first respective position information includes (and/or is) first position information, the first device changes (806), based on the first respective position information, a state of an input and/or output (I/O) component (e.g., a camera and/or a movement component) of the first device (e.g., the state of the I/O component of the first device is changed to a first state in accordance with a determination that the first respective position information includes third position information) (e.g., the state of the I/O component of the first device is changed to a second state different from the first state in accordance with a determination that the first respective position information includes fourth position information different from the third position information).

In response to (804) receiving the first respective position information of the second device, in accordance with a determination that the first respective position information includes (and/or is) second position information different from the first position information, the first device changes (808), based on the first respective position information, a state of an I/O component (e.g., a camera and/or a movement component) of a third device (e.g., a mount of the first device, a device mounted to the first device, a computer system, a personal device, an accessory device, a controller device, a smart phone, a smart watch, a fitness tracking device, a tablet, a head-mounted display (HMD) device, a speaker, a smart light, a laptop, an electronic device, and/or another type of computer system) (e.g., with or without changing a state of an I/O component of the first device) (e.g., the state of the I/O component of the third device is changed to a third state in accordance with a determination that the first respective position information includes fifth position information) (e.g., the state of the I/O component of the third device is changed to a fourth state different from the third state in accordance with a determination that the first respective position information includes sixth position information different from the fifth position information) different from the first device and the second device.

In some embodiments, the first respective position information is received via a first communication mode (e.g., a radio band and/or channel, packet format, and/or technology (e.g., Bluetooth, Wi-Fi, cellular, and/or NFC)) (e.g., from the second device) (and/or not the second communication mode). In some embodiments, changing the state of the I/O component of the third device includes sending, to the third device via a second communication mode (and/or not the first communication mode) different from the first communication mode, a request (e.g., an instruction, a message, and/or a command) to change the state of the I/O component of the third device. In some embodiments, the request does not include the first respective position information (and/or a portion of the first respective position information).

In some embodiments, the first communication mode has a first communication range (e.g., range of communication, such as range of reception and/or effective reach of transmission). In some embodiments, the second communication mode has a second communication range shorter than the first communication range. In some embodiments, the second communication mode is a Bluetooth and/or NFC communication and the first communication mode is a cellular and/or Wi-Fi communication.

In some embodiments, the second communication mode is lower power (e.g., lower total amount of energy over time) than the first communication mode. In some embodiments, the second communication mode is a Bluetooth and/or NFC communication and the first communication mode is a cellular and/or Wi-Fi communication.

In some embodiments, the second communication mode is a peer-to-peer communication (e.g., a peer-to-peer communication, Bluetooth, and/or NFC). In some embodiments, the first communication mode communicates data via an access point (e.g., Wi-Fi and/or cellular communication).

In some embodiments, changing the state of the I/O component of the first device includes moving (e.g., repositioning, tilting, and/or rotating) the I/O component of the first device from a first physical position to a second physical position different from the first physical position. In some embodiments, the first physical position and/or the second physical position is different from the first respective position.

In some embodiments, the first device is in communication with (and/or includes) a first camera. In some embodiments, changing the state of the I/O component of the first device includes zooming (e.g., digitally zooming, zooming in, zooming out, and/or changing a zoom level (e.g., level of magnification and/or focal length) from a first zoom level to a second zoom level different from the first zoom level) the first camera of the first device.

In some embodiments, changing the state of the I/O component of the third device includes moving (e.g., repositioning, tilting, and/or rotating) the I/O component of the third device from a third physical position to a fourth physical position different from the third physical position. In some embodiments, the first device is in communication with (and/or includes) a camera. In some embodiments, moving the I/O component of the third device to the fourth physical position causes and/or results in a change in a field of view (e.g., from a first field of view to a second field of view different from the first field of view) of the camera. In some embodiments, the third physical position and/or the fourth physical position is different from the first respective position.

In some embodiments, changing the state of the I/O component of the first device includes converting (e.g., transforming and/or changing) the first respective position information into a first set of one or more instructions (e.g., zoom, translate, move, rotate, and/or change orientation) for the I/O component of the first device. In some embodiments, changing the state of the I/O component of the third device includes converting the first respective position information into a second set of one or more instructions for the I/O component of the third device. In some embodiments, the second set of one or more instructions is different from the first set of one or more instructions.

In some embodiments, the second device includes a first mobility range (e.g., degrees of freedom of movement, axis of movement, and/or movement potential). In some embodiments, the first device includes a second mobility range different from the first mobility range. In some embodiments, the second mobility range includes a larger amount of mobility (e.g., more degrees of movement, additional axis of movement, and/or larger movement potential) than the first mobility range. In some embodiments, converting the first respective position information into the first set of one or more instructions for the I/O component of the first device includes transforming (e.g., converting and/or changing) the first respective position information from being with respect to the first mobility range to being with respect to the second mobility range. In some embodiments, the third device includes a third mobility range. In some embodiments, the second mobility range includes a larger amount of mobility than the third mobility range.

In some embodiments, the I/O component includes a second camera. In some embodiments, the first set of one or more instructions includes a digital zoom (e.g., zoom in or zoom out) instruction for the second camera. In some embodiments, the first set of one or more instructions includes a digital zoom-in instruction for the second camera as a result of the first respective position information including position information corresponding to the second device moving in a first direction. In some embodiments, the first set of one or more instructions includes a digital zoom-out instruction for the second camera as a result of the first respective position information including position information corresponding to the second device moving in a second direction different from (and/or opposite to) the first direction.

In some embodiments, changing the state of the I/O component of the third device includes: in accordance with a determination that the first respective position information corresponds to a first position and that the I/O component of the third device is not able to move to (e.g., does not have a range of motion that includes) the first position, moving the I/O component of the third device to a second position different from the first position; and in accordance with a determination that the first respective position information corresponds to the first position and that the I/O component of the third device is able to move to (e.g., has a range of motion that includes) the first position, moving the I/O component of the third device to the first position (e.g., instead of the second position). In some embodiments, the first device includes a first degree of freedom of movement (e.g., axis, and/or rotation). In some embodiments, the second device includes a second degree of freedom of movement different from the first degree of freedom of movement. In some embodiments, the third device includes a third degree of freedom of movement different from the first degree of freedom of movement and/or the second degree of freedom of movement. In some embodiments, changing the state of the I/O component of the third device includes converting (e.g., transforming and/or changing) the first respective position information from a position in the first degree of freedom of movement to a position in the third degree of freedom of movement. In some embodiments, the position in the first degree of freedom of movement cannot be achieved (e.g., cannot be reached and/or moved to) by the I/O component of the third device because the I/O component of the third device does not have the first degree of freedom of movement and instead has the third degree of freedom of movement. In some embodiments, the second set of one or more instructions for the third degree of freedom of movement includes an adjacent position corresponding to the second position information along the third degree of freedom. In some embodiments, the second position is adjacent, nearby, and/or within a threshold of the first position.

In some embodiments, changing the state of the I/O component of the third device includes: converting (e.g., transforming and/or changing) the first respective position information into a second set of one or more instructions (e.g., zoom, translate, move, rotate, and/or change orientation) for the I/O component of the third device; and sending (e.g., transmitting and/or communicating) the second set of one or more instructions to the third device. In some embodiments, the second set of one or more instructions do not include the first respective position information. In some embodiments, the second set of one or more instructions includes an identification of an operation to be performed by the third device. In some embodiments, the second set of one or more instructions includes the first respective position information.

In some embodiments, changing the state of the I/O component of the third device does not include sending the first respective position information to the third device. In some embodiments, sending the second set of one or more instructions to the third device does not include sending the first respective position information to the third device. In some embodiments, the first respective position information is not sent to the third device. In some embodiments, the second set of one or more instructions do not includes the first respective position information.

In some embodiments, the state of the I/O component of the first device is a first state. In some embodiments, the state of the I/O component of the third device is a second state. In some embodiments, in response to receiving the first respective position information of the second device and in accordance with a determination that the first respective position information includes (and/or is) third position information (e.g., different from the first position information and the second position information), the first device changes, based on the first respective position information, a third state of the I/O component of the first device and a fourth state of the I/O component of the third device.

In some embodiments, the state of the I/O component of the first device is a fifth state. In some embodiments, the state of the I/O component of the third device is a sixth state. In some embodiments, in response to receiving the first respective position information of the second device and in accordance with a determination that the first respective position information includes (and/or is) fourth position information different from the first position information and the second position information (and/or different from the third position information), the first device forgoes changing (e.g., maintains) a seventh state of the I/O component of the first device and an eighth state of the I/O component of the third device.

In some embodiments, the state of the I/O component of the third device is a ninth state. In some embodiments, the first device receives (e.g., after changing the state of the I/O component of the third device), from the second device, second respective position information (e.g., different from the first respective position information) of the second device. In some embodiments, in response to receiving the second respective position information of the second device, in accordance with a determination that the first device is in communication with the third device via a first manner (e.g., physically, mechanically, magnetically, and/or wirelessly (e.g., Bluetooth, Wi-Fi, cellular, and/or NFC)), the first device changes, based on the second respective position information, a tenth state of the I/O component of the third device. In some embodiments, changing the tenth state of the I/O component of the third device includes changing the tenth state of the I/O component of the third device to a different state than changing the ninth state of the I/O component of the third device. In some embodiments, in response to receiving the second respective position information of the second device, in accordance with a determination that the first device is not in communication with the third device via the first manner (and/or that the first device is in communication with the third device via a second manner different from the first manner), the first device forgoes changing the tenth state of the I/O component of the third device (and/or forgoing changing a state of an I/O component of a different device).

In some embodiments, the first device is in communication with (and/or connected to) the third device while the first device receives, from the second device, the first respective position information.

In some embodiments, the first device is not in communication with the third device while the first device receives, from the second device, the first respective position information. In some embodiments, the first device is in communication with (and/or connected to) the third device while changing, based on the first respective position information, the state of the I/O component of the third device. In some embodiments, the first device initiates communication with the third device in response to receiving the first respective position information of the second device and/or in accordance with a determination that the first respective position information includes (and/or is) the second position information.

In some embodiments, while (and/or before and/or after) receiving, from the second device, the first respective position information, the first device sends (e.g., streams, transmits, and/or communicates), to the second device, data (e.g., media data (e.g., video, photo, and/or HMD media) and/or commands (e.g., inputs and/or requests to output)).

In some embodiments, the data includes third position information of the third device (and/or the first device). In some embodiments, the third position information is embedded into the data, such as when the data includes media data (e.g., an image and/or a video).

In some embodiments, before receiving the first respective position information, the first device receives, from the third device, the third position information. In some embodiments, while (and/or before) sending the data to the second device, the first device is in communication with the third device. In some embodiments, while (and/or after) sending the data to the second device, the first device receives, from the third device, position information of the third device.

In some embodiments, the first device is in communication with (and/or includes) a third camera. In some embodiments, the first device captures, via the third camera, an image of an environment (e.g., physical or virtual environment), wherein the third position information of the third device is determined from the image (e.g., and not received from the third device). In some embodiments, the third device is in the image. In some embodiments, the third device is not in the image but instead a reference point and/or object in the image is used to determine the third position information.

In some embodiments, the data includes first media data (e.g., video, photo, and/or HMD media). In some embodiments, the first device is in communication with a third camera. In some embodiments, the first media data is captured via the third camera.

In some embodiments, the second device is a head mounted display device. In some embodiments, the third device is a mount (e.g., of the first device).

In some embodiments, the first device is a personal device (e.g., a smartphone, a smart watch, a fitness tracking device, a tablet, a HMD device, a smart light, a laptop, an electronic device, and/or another type of computer system). In some embodiments, the personal device is operated by a user.

In some embodiments, after changing the state of the I/O component of the first device, the first device receives, from the second device, third respective position information of the second device, wherein the third respective position information is different from the first respective position information. In some embodiments, in response to receiving the third respective position information of the second device (e.g., and in accordance with a determination that the third respective position information includes (and/or is) the second position information), the first device changes, based on the third respective position information, the state of the I/O component of the third device (e.g., without changing the state of the I/O component of the first device).

In some embodiments, after changing the state of the I/O component of the first device, the first device receives, from the second device, fourth respective position information of the second device, wherein the fourth respective position information is different from the first respective position information. In some embodiments, in response to receiving the fourth respective position information of the second device, in accordance with a determination that the fourth respective position information includes (and/or is) the first position information, the first device changes, based on the fifth respective position information, the state of the I/O component of the first device. In some embodiments, in response to receiving the fourth respective position information of the second device, in accordance with a determination that the fourth respective position information includes (and/or is) the second position information, the first device changes, based on the fourth respective position information, the state of the I/O component of the third device.

In some embodiments, the first respective position information corresponds to a first field of view (e.g., that a user of the second device wants to see using the first device and/or the third device). In some embodiments, after (and/or while) changing the state of the third device, the first device sends, to the second device, media data (e.g., video, photo, and/or HMD media) corresponding to the first field of view (e.g., the second device is requesting that the first device change a field of view of media being sent to the second device using the first device and/or the third device).

Note that details of the processes described above with respect to process 800 (e.g., FIG. 8) are also applicable in an analogous manner to other processes described herein. For example, process 500 optionally includes one or more of the characteristics of the various processes described above with reference to process 800. For example, establishing a secure connection in response to detecting the computer system is coupled to the mount of process 500 can occur before changing the state of an input and/or output (I/O) component of a third device of process 800. For brevity, these details are not repeated herein.

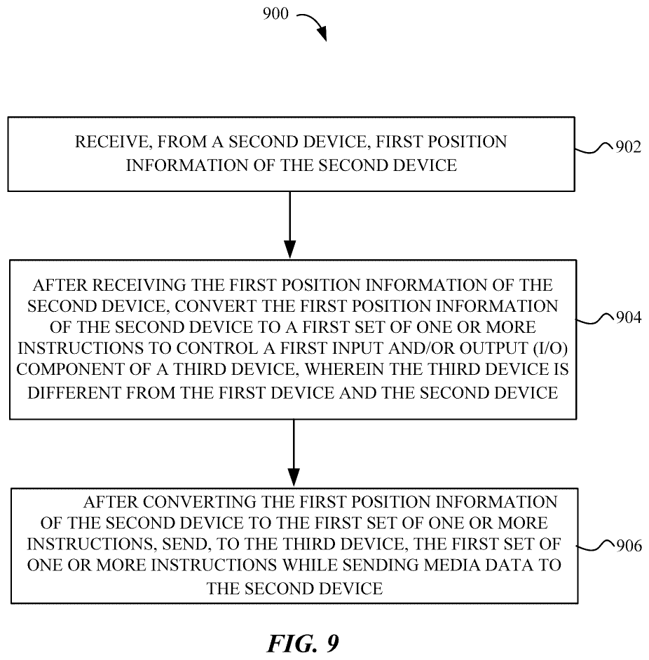

FIG. 9 is a flow diagram illustrating a method (e.g., process 900) for communicating between devices in accordance with some embodiments. Some operations in process 900 are, optionally, combined, the orders of some operations are, optionally, changed, and some operations are, optionally, omitted.

As described below, process 900 provides an intuitive way for communicating between devices. Process 900 reduces the cognitive burden on a user, thereby creating a more efficient human-machine interface. For battery-operated computing devices, enabling a user to interact with such devices faster and more efficiently conserves power and increases the time between battery charges.

In some embodiments, process 900 is performed at a first device (e.g., a computer system, a personal device, an accessory device, a controller device, a smart phone, a smart watch, a fitness tracking device, a tablet, a head-mounted display (HMD) device, a speaker, a smart light, a laptop, an electronic device, and/or another type of computer system).

The first device receives (902), from a second device (e.g., a computer system, a personal device, an accessory device, a controller device, a smart phone, a smart watch, a fitness tracking device, a tablet, a head-mounted display (HMD) device, a speaker, a smart light, a laptop, an electronic device, and/or another type of computer system) different from the first device, first position (e.g., orientation and/or location) information of the second device (e.g., a position in which a user of the second device wants to see with respect to a field of view of the first device).

After (and/or in response to) receiving the first position information of the second device, the first device converts (904) (e.g., transforming and/or changing) the first position information of the second device to a first set of one or more instructions to control a first input and/or output (I/O) component (e.g., a camera and/or a movement component) of a third device (e.g., a mount of the first device, a device mounted to the first device, a computer system, a personal device, an accessory device, a controller device, a smart phone, a smart watch, a fitness tracking device, a tablet, a head-mounted display (HMD) device, a speaker, a smart light, a laptop, an electronic device, and/or another type of computer system), wherein the third device is different from the first device and the second device.

After (and/or in response to) converting the first position information of the second device to the first set of one or more instructions, the first device sends (906), to the third device, (e.g., controls, causes movement of, and/or modifies a state of the third device via) the first set of one or more instructions while sending (e.g., the first device sends) media data (e.g., an image and/or a video) to the second device.

In some embodiments, the first device is in communication with (and/or includes) a first camera. In some embodiments, before sending, to the third device, the first set of one or more instructions (and/or before, after, and/or in response to converting the first position information of the second device to the first set of one or more instructions), the first device captures, via the first camera, the media data.

In some embodiments, the media data is captured via a camera of the third device (e.g., before the first device sends, to the third device, the first set of one or more instructions (and/or before, after, and/or in response to the first device converting the first position information of the second device to the first set of one or more instructions)).

In some embodiments, the first device is in communication with the second device and the third device while the first devices receives, from the second device, the first position information of the second device.

In some embodiments, converting the first position information of the second device to the first set of one or more instructions includes changing (e.g., transforming and/or converting) from a first mobility range (e.g., degrees of freedom of movement, axis of movement, and/or movement potential) to a second mobility range less than the first mobility range.

In some embodiments, the first device is in communication with (and/or includes) a second I/O component separate from the first I/O component. In some embodiments, after receiving the first position information of the second device (and/or in conjunction with (before, while, in response to, and/or after) converting the first position information of the second device to the first set of one or more instructions to control the I/O component of the third device), the first device converts (e.g., transforming and/or changing) the first position information of the second device to a second set of one or more instructions to control the second I/O component, wherein the second set of one or more instructions are separate from the first set of one or more instructions. In some embodiments, the second set of one or more instructions are the same as the first set of one or more instructions. In some embodiments, the second set of one or more instructions are different from the first set of one or more instructions. In some embodiments, after (and/or in response to) converting the position information of the second device to the second set of one or more instructions to control the second I/O component, causing the second I/O component to change from a first state to a second state different from the first state (e.g., in conjunction with (e.g., before, after, in response to, and/or concurrently with) sending, to the third device, the first set of one or more instructions) (e.g., while sending media data to the second device).

In some embodiments, after sending, to the third device, the first set of one or more instructions, the first device receives, from the second device, second position information of the second device separate from the first position information. In some embodiments, the second position information is different from the first position information. In some embodiments, the second position information is the same as the first position information. In some embodiments, after (and/or in response to) receiving the second position information of the second device, in accordance with a determination that a current position (e.g., of the second device and/or the third device) is a first position, the first device sends, to the third device, a third set of one or more instructions. In some embodiments, after receiving the second position information of the second device, in accordance with a determination that the current position is a second position different from the first position, the first device sends, to the third device, a fourth set of one or more instructions different from the third set of one or more instructions.

In some embodiments, the first position information is received via a first communication mode (e.g., as described above with respect to process 800). In some embodiments, the first set of one or more instructions is sent via a second communication mode different from the first communication mode.

In some embodiments, sending, to the third device, the first set of one or more instructions causes a physical position (e.g., location and/or orientation) of the third device to change from a first physical position to a second physical position different from the first physical position (e.g., and, as a result, changing a field of view of a camera of the first device). In some embodiments, the first device is in communication with and/or includes a second camera. In some embodiments, sending, to the third device, the first set of one or more instructions causes a field of view of a camera of the first device to change from a first field of view to a second field of view different from the first field of view.

In some embodiments, before (and/or after) sending, to the third device, the first set of one or more instructions and while sending the media data (and/or other media data, such as other media data that is part of the same stream as the media data) to the second device, the first device receives, from the second device, third position information of the second device, wherein the third position information is separate from the first position information. In some embodiments, the third position information is different from the first position information. In some embodiments, the third position information is the same as the first position information. In some embodiments, in response to receiving the third position information of the second device, the first device changes, based on the third position information, a state of the first device (e.g., a state of an I/O component of the first device) (e.g., instead of sending, to the third device, a set of one or more instructions) (e.g., instead of changing a state of the third device (e.g., a state of an I/O component of the third device)) from a first state to a second state different from the first state.

In some embodiments, before (and/or after) sending, to the third device, the first set of one or more instructions, the first device receives, from the second device, fourth position information of the second device, wherein the fourth position information is separate from the first position information. In some embodiments, the fourth position information is different from the first position information. In some embodiments, the fourth position information is the same as the first position information. In some embodiments, in response to receiving the fourth position information of the second device, in accordance with a determination that the first device is coupled (e.g., wired, wirelessly, or magnetically) to the third device, the first device sends, to the third device, a fifth set of one or more instructions separate from the first set of one or more instructions. In some embodiments, the fifth set of one or more instructions are the same as the first set of one or more instructions. In some embodiments, the fifth set of one or more instructions is the same as the first set of one or more instructions. In some embodiments, in response to receiving the fourth position information of the second device, in accordance with a determination that the first device is not coupled to the third device, the first device forgoes sending, to the third device, the fifth set of one or more instructions (e.g., while the first device is in communication with and/or connected to (such as wirelessly) the third device).

In some embodiments, the determination that the first device is coupled to the third device includes a determination that a magnetic field strength associated with the third device exceeds a threshold strength (e.g., 1-10 tesla and/or 1-500 gauss). In some embodiments, the determination that the first device is not coupled to the third device includes a determination that a magnetic field strength associated with the third device does not exceed a threshold strength.

In some embodiments, the determination that the first device is coupled to the third device includes a determination that the first device is in communication with the third device via a short range communication channel (e.g., Near Field Communication, Bluetooth low energy, and/or Radio-Frequency Identification). In some embodiments, the determination that the first device is not coupled to the third device includes a determination that the first device is not in communication with the third device via a short range communication channel.

In some embodiments, the determination that the first device is coupled to the third device includes a determination that a signal strength associated with (and/or corresponding to) the third device exceeds a threshold (e.g., an amount of decibels of a signal relative to a milliwatt). In some embodiments, the determination that the first device is coupled to the third device includes a determination that a received signal strength indicator (RSSI) exceeds an RSSI threshold. In some embodiments, the determination that the first device is not coupled to the third device includes a determination that a signal strength associated with (and/or corresponding to) the third device does not exceed the threshold.

In some embodiments, the determination that the first device is coupled to the third device includes a determination that the first device is moving relative to the third device. In some embodiments, the determination that the first device is not coupled to the third device includes a determination that the first device is not moving relative to the third device. In some embodiments, the determination that the first device is coupled to the third device includes a determination that the third device is moving relative to the first device. In some embodiments, the determination that the first device is not coupled to the third device includes a determination that the third device is not moving relative to the first device. In some embodiments, the determination that the first device is moving relative to the third device includes a comparison of sensor data from an inertial measurement unit of the first device with sensor data from an inertial measurement unit of the third device.

In some embodiments, the determination that the first device is coupled to the third device includes a determination that a physical coupling component (e.g., of the first device and/or the third device) is engaged (e.g., via receiving, from the third device, that the physical coupling component is engaged).

In some embodiments, before (and/or after) sending, to the third device, the first set of one or more instructions, the first device receives, from the second device, fifth position information of the second device, wherein the fifth position information is separate from the first position information. In some embodiments, the fifth position information is different from the first position information. In some embodiments, the fifth position information is the same as the first position information. In some embodiments, in response to receiving the fifth position information of the second device, in accordance with a determination that the first device is coupled (e.g., wired, wirelessly, or magnetically) to the third device, the first device converts the fifth position information to a sixth set of one or more instructions separate from the first set of one or more instructions. In some embodiments, the sixth set of one or more instructions is the same as the first set of one or more instructions. In some embodiments, the sixth set of one or more instructions is the same as the first set of one or more instructions. In some embodiments, after converting the fifth position information to the sixth set of one or more instructions, the first device sends, to the third device, the sixth set of one or more instructions while sending media data to the second device. In some embodiments, in response to receiving the fifth position information of the second device, in accordance with a determination that the first device is not coupled to the third device, the first device converts the fifth position information to a seventh set of one or more instructions different from the sixth set of one or more instructions (e.g., and/or separate from the first set of one or more instructions) (e.g., while the first device is in communication with and/or connected to (such as wirelessly) the third device). In some embodiments, after (and/or in response) converting the fifth position information to the seventh set of one or more instructions, the first device executes the seventh set of one or more instructions (e.g., causing a state of the first device (e.g., a state of an I/O component of the first device) to change).

In some embodiments, the second device is a HMD device. In some embodiments, the third device is a mount (and/or of the first device).

In some embodiments, the first device is a personal device (e.g., a smartphone, a smart watch, a fitness tracking device, a tablet, a HMD device, a smart light, a laptop, an electronic device, and/or another type of computer system). In some embodiments, the personal device is operated by a user.

Note that details of the processes described above with respect to process 900 (e.g., FIG. 9) are also applicable in an analogous manner to the processes described herein. For example, process 500 optionally includes one or more of the characteristics of the various processes described herein with reference to process 900. For example, receiving a request to establish the secure communication between the computer system and the mount of process 500 can occur before sending media data to the second device of process 900. For brevity, these details are not repeated herein.

The foregoing description, for purpose of explanation, has been described with reference to specific examples. However, the illustrative discussions above are not intended to be exhaustive or to limit the disclosure to the precise forms disclosed. Many modifications and variations are possible in view of the above teachings. The examples were chosen and described in order to best explain the principles of the techniques and their practical applications. Others skilled in the art are thereby enabled to best utilize the techniques and various examples with various modifications as are suited to the particular use contemplated.

Although the disclosure and examples have been fully described with reference to the accompanying drawings, it is to be noted that various changes and modifications will become apparent to those skilled in the art. Such changes and modifications are to be understood as being included within the scope of the disclosure and examples as defined by the claims.

As described above, one aspect of the present technology is the gathering and use of data available from various sources to improve how a device interacts with a user. The present disclosure contemplates that in some instances, this gathered data can include personal information data that uniquely identifies or can be used to contact or locate a specific person. Such personal information data can include demographic data, location-based data, telephone numbers, email addresses, home addresses, or any other identifying information.

The present disclosure recognizes that the use of such personal information data, in the present technology, can be used to the benefit of users. For example, the personal information data can be used to change how a device interacts with a user. Accordingly, use of such personal information data enables better user interactions. Further, other uses for personal information data that benefit the user are also contemplated by the present disclosure.

The present disclosure further contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. For example, personal information from users should be collected for legitimate and reasonable uses of the entity and not shared or sold outside of those legitimate uses. Further, such collection should occur only after receiving the informed consent of the users. Additionally, such entities would take any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of image capture, the present technology can be configured to allow users to select to “opt in” or “opt out” of participation in the collection of personal information data during registration for services.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data.

What is claimed is:

1. A method, comprising:
at a first device:
receiving, from a second device different from the first device, first respective position information of the second device; and
in response to receiving the first respective position information of the second device:
in accordance with a determination that the first respective position information includes first position information, changing, based on the first respective position information, a state of an input and/or output (I/O) component of the first device; and
in accordance with a determination that the first respective position information includes second position information different from the first position information, changing, based on the first respective position information, a state of an I/O component of a third device different from the first device and the second device.

2. The method of claim 1, wherein the first respective position information is received via a first communication mode, and wherein changing the state of the I/O component of the third device includes sending, to the third device via a second communication mode different from the first communication mode, a request to change the state of the I/O component of the third device.

3. The method of claim 2, wherein the first communication mode has a first communication range, and wherein the second communication mode has a second communication range shorter than the first communication range.

4. The method of claim 2, wherein the second communication mode is lower power than the first communication mode.

5. The method of claim 2, wherein the second communication mode is a peer-to-peer communication.

6. The method of claim 1, wherein changing the state of the I/O component of the first device includes moving the I/O component of the first device from a first physical position to a second physical position different from the first physical position.

7. The method of claim 1, wherein the first device is in communication with a first camera, and wherein changing the state of the I/O component of the first device includes zooming the first camera of the first device.

8. The method of claim 1, wherein changing the state of the I/O component of the third device includes moving the I/O component of the third device from a third physical position to a fourth physical position different from the third physical position.

9. The method of claim 1, wherein changing the state of the I/O component of the first device includes converting the first respective position information into a first set of one or more instructions for the I/O component of the first device.

10. The method of claim 9, wherein:
the second device includes a first mobility range;
the first device includes a second mobility range different from the first mobility range; and
the second mobility range includes a larger amount of mobility than the first mobility range.

11. The method of claim 9, wherein the I/O component includes a second camera, and wherein the first set of one or more instructions includes a digital zoom instruction for the second camera.

12. The method of claim 1, wherein changing the state of the I/O component of the third device includes:
in accordance with a determination that the first respective position information corresponds to a first position and that the I/O component of the third device is not able to move to the first position, moving the I/O component of the third device to a second position different from the first position; and
in accordance with a determination that the first respective position information corresponds to the first position and that the I/O component of the third device is able to move to the first position, moving the I/O component of the third device to the first position.

13. The method of claim 1, wherein changing the state of the I/O component of the third device includes:
converting the first respective position information into a second set of one or more instructions for the I/O component of the third device; and
sending the second set of one or more instructions to the third device.

14. The method of claim 13, wherein changing the state of the I/O component of the third device does not include sending the first respective position information to the third device.

15. The method of claim 1, wherein the state of the I/O component of the first device is a first state, wherein the state of the I/O component of the third device is a second state, the method further comprising:
in response to receiving the first respective position information of the second device and in accordance with a determination that the first respective position information includes third position information, changing, based on the first respective position information, a third state of the I/O component of the first device and a fourth state of the I/O component of the third device.

16. The method of claim 1, wherein the state of the I/O component of the first device is a fifth state, wherein the state of the I/O component of the third device is a sixth state, the method further comprising:
in response to receiving the first respective position information of the second device and in accordance with a determination that the first respective position information includes fourth position information different from the first position information and the second position information, forgoing changing a seventh state of the I/O component of the first device and an eighth state of the I/O component of the third device.

17. The method of claim 1, wherein the state of the I/O component of the third device is a ninth state, the method further comprising:
receiving, from the second device, second respective position information of the second device; and
in response to receiving the second respective position information of the second device:
in accordance with a determination that the first device is in communication with the third device via a first manner, changing, based on the second respective position information, a tenth state of the I/O component of the third device; and
in accordance with a determination that the first device is not in communication with the third device via the first manner, forgoing changing the tenth state of the I/O component of the third device.

18. The method of claim 1, wherein the first device is in communication with the third device while the first device receives, from the second device, the first respective position information.

19. The method of claim 1, wherein the first device is not in communication with the third device while the first device receives, from the second device, the first respective position information.

20. The method of claim 1, further comprising:
while receiving, from the second device, the first respective position information, sending, to the second device, data.

21. The method of claim 20, wherein the data includes third position information of the third device.

22. The method of claim 21, further comprising:
before receiving the first respective position information, receiving, from the third device, the third position information.

23. The method of claim 21, wherein the first device is in communication with a third camera, the method further comprising:
capturing, via the third camera, an image of an environment, wherein the third position information of the third device is determined from the image.

24. The method of claim 20, wherein the data includes first media data.

25. The method of claim 1, wherein the second device is a head mounted display device, and wherein the third device is a mount.

26. The method of claim 25, wherein the first device is a personal device.

27. The method of claim 1, further comprising:
after changing the state of the I/O component of the first device, receiving, from the second device, third respective position information of the second device, wherein the third respective position information is different from the first respective position information; and
in response to receiving the third respective position information of the second device, changing, based on the third respective position information, the state of the I/O component of the third device.

28. The method of claim 1, further comprising:
after changing the state of the I/O component of the first device, receiving, from the second device, fourth respective position information of the second device, wherein the fourth respective position information is different from the first respective position information; and
in response to receiving the fourth respective position information of the second device:
in accordance with a determination that the fourth respective position information includes the first position information, changing, based on the fifth respective position information, the state of the I/O component of the first device; and
in accordance with a determination that the fourth respective position information includes the second position information, changing, based on the fourth respective position information, the state of the I/O component of the third device.

29. The method of claim 1, wherein the first respective position information corresponds to a first field of view, the method further comprising:
after changing the state of the third device, sending, to the second device, media data corresponding to the first field of view.

30. A non-transitory computer-readable storage medium storing one or more programs configured to be executed by one or more processors of a first device, the one or more programs including instructions for:
receiving, from a second device different from the first device, first respective position information of the second device; and
in response to receiving the first respective position information of the second device:
in accordance with a determination that the first respective position information includes first position information, changing, based on the first respective position information, a state of an input and/or output (I/O) component of the first device; and
in accordance with a determination that the first respective position information includes second position information different from the first position information, changing, based on the first respective position information, a state of an I/O component of a third device different from the first device and the second device.

31. A first device, comprising:
one or more processors; and
memory storing one or more programs configured to be executed by the one or more processors, the one or more programs including instructions for:
receiving, from a second device different from the first device, first respective position information of the second device; and
in response to receiving the first respective position information of the second device:
in accordance with a determination that the first respective position information includes first position information, changing, based on the first respective position information, a state of an input and/or output (I/O) component of the first device; and
in accordance with a determination that the first respective position information includes second position information different from the first position information, changing, based on the first respective position information, a state of an I/O component of a third device different from the first device and the second device.
